(19) United States
(12) Patent Application Publication
(10) Pub. No.: US 2005/0065867 A1
(43) Pub. Date: Mar. 24, 2005

(54) Demand-and-supply intervening system, demand-and-supply intervening method, and demand-and-supply intervening support program

(76) Inventors: Hideyuki Aisu, Kawasaki-shi (JP); Keiichi Handa, Inagi-shi (JP); Toshiaki Tanaka, Yokohama-shi (JP); Tomoshi Otsuki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/896,996

(22) Filed: Jul. 23, 2004

(30) Foreign Application Priority Data
Jul. 25, 2003 (JP) 2003-279886

(51) Int. Cl. G06F 17/60

(52) U.S. Cl. 705/37

(57) ABSTRACT

A demand-and-supply intervening system which supports determination of a demand-and-supply relationship between users in association with demand resources and supply resources between a plurality of users, comprises an entry acquisition unit for creating an entry set by collecting a plurality of entries each of which has a plurality of resources as demand/supply objects and a combinatorial condition to be satisfied between resources, and a candidate group determination unit for extracting a candidate group of entries so that all entries included in the candidate group satisfy combinatorial conditions included in each entry when extracting the candidate group having a plurality of entry which includes at least one entry designated as a base point, and determining the presence/absence of demand-and-supply relationships between demand and supply resources between entries which belong to the candidate group and demand-and-supply quantities.

### CROSS-REFERENCE TO RELATED APPLICATION

This application is based upon and claims the benefit of priority from the prior Japanese Patent Application No. 2003-279886, filed Jul. 25, 2003, the entire contents of which are incorporated herein by reference.

### BACKGROUND OF THE INVENTION

1. Field of the Invention

The present invention relates to a technique which is applied to a demand-and-supply trading market system such as a power trading market system using a communication network, and a demand-and-supply determination support system of manpower, articles, equipment, services, and the like among companies/departments, and so on, and supports a determination process of an appropriate demand-and-supply relationship of required resources and those to be provided among a plurality of users and, also to a technique that finds (extracts) an appropriate demand-and-supply relationship (demand-and-supply destinations, demand-and-supply quantities) of respective participants, and intervening demand and supply by providing information of that demand-and-supply relationship to the users.

2. Description of the Related Art

So-called demand-and-supply intervening systems such as a demand-and-supply trading market system using a network, a system that supports a demand-and-supply plan of resources such as manpower, articles, equipment, services, and the like among companies/departments, and so forth have been put into practical use in various fields. Note that in this specification, a “demand-and-supply intervening system” indicates a so-called decision making support system that supports establishment of a smooth demand-and-supply relationship by presenting candidates of partner users as resource demand/supply objects and demand/supply quantities to respective users of the system, and additional functions such as personal authentication, settlement support, security support, and the like are checked off.

As a conventional demand-and-supply intervening system, an information search system using a database, i.e., a system called a bulletin board system, is the most prevalent. As a basis of this system, a plurality of users register resources that they want to provide and to acquire via a network. Individual users retrieve and confirm resource candidates which meet their conditions. Then, the system supports each user to reach a settlement of demand and supply with another user as a registrant of his or her desired resource.

As a typical demand-and-supply intervening system in a trading market, a system based on a call auction system is known. In this system, registration of resources (commodities) is halted all at once, a trade between a provider who sets the lowest price and a consumer who sets the highest price for the sample type of resources is carried out in turn until the price set by a provider becomes lower than that set by the consumer. Also, a double auction system (nearly equivalent to a continuous trading system) is known. In this system, resource registration and demand-and-supply settlement timings are free, and a trade between a provider who sets the lowest price and a consumer who sets the highest price for the same type of resources is carried out instantly. Such system is used in a stock trading system.

When the liberalization of electricity trades starts, it is expected that a demand-and-supply intervening system in electricity trades will be used. In Japan, a spot trading system, will be the call auction system for bits of 30 min, and the long term trading will be continuous trading system.

In demand-and-supply intervening, demand and supply are to be intervened while designating a combinatorial condition of resources in addition to demand-and-supply intervening for respective types of resources. For example, a demand “want to buy sets of personal computers, displays, and printers for 200,000 yen per set” may arise. The number of resources of one type may be pluralized, and a demand “want to provide a set of 100 personal computers and 100 displays for 20,000,000 yen” may arise.

A power trading support system will be exemplified. For the power generation-side user, the upper- and lower-limit constraints of the possible generated electricity volume are normally given as time-series patterns depending on the characteristics in terms of operation of generating facilities (e.g., when it is unprofitable unless power generation for a predetermined volume or more is continued for a predetermined period of time once power generation starts, or when power generation is allowed only for a predetermined volume, and so forth). For the demand-side user, electric power that meets all power consumption patterns for respective time bands must be stably assured so as to perform activities such as manufacture, and the like. For a user who participates as an aggregator, since it is very difficult to preserve a large volume of electric power, the acquired and resale electric power volumes must be equiponderated in respective time bands. A user who provides transmission facilities must suppress the total volume of electric power that flows through the respective transmission facilities to fall within a designated range.

In a conventional demand-and-supply intervening system (except for a system described in A. Kothari, T. Sandholm, Subhash Suri, “Solving Combinatorial Exchanges: Optimality via a Few Partial Bids”, (to be referred to as a cited reference hereinafter)), when users register a plurality of resources at the same time, and more than one user among them designate constraints to be met among resources, the constrains designated by one specific user can be met, but it is technically difficult to intervene while simultaneously meeting the partner's constraints. This is because the conventional demand-and-supply intervening system is merely a simple information search system using a database, and has no support function based on a combinatorial optimization operation required to consider the constraints designated by a plurality of users at the same time.

For this reason, a plurality of users cannot freely designate combinatorial constrains among a plurality of resources.

In the power trading support system as well, an intervening system based on the call auction system or simple continuous trading system is premised on that electricity is registered (bid) as unrelated commodities for respective time bands. Hence, combinatorial conditions between even commodities registered by same user cannot be designated. For this reason, the simple demand-and-supply intervening system cannot generally handle combinatorial condition designation that takes the characteristics such as the aforementioned characteristics in terms of operation of generating facilities, power consumption patterns required for business, and the like.

When a method called a combinatorial auction (see Jpn. Pat. Appln. KOKAI Publication No. 2002-163486, and U.S. Pat. No. 6,972,473) is used, an auction based on bids upon designating a condition as a combination of resources under a specific condition is allowed. In the combinatorial auction, the number of bids of either the user on the resource provider side or the user on the consumer side is limited to one. As the latest system as an enhanced system of the combinatorial auction, a system that allows both the resource provider side and consumer side to simultaneously handle a plurality of bids has been proposed (see the cited reference). The cited reference is premised on that the intervening system simultaneously determines only whether or not all bids can participate in trades (winner determination), and all users conform to the determination of the intervening system.

For reference, optimization formulas (1) of the cited reference are:

$$max {\sum }_{j ∈ B} pjxj \\ such that \\ \sum qijxj \leq 0 ∀ i ∈ I \\ \begin{matrix}where I \text{: a set of resouces} \\ B \text{: a set of bids} \\ {x}_{j} \text{: a decision variable of bid} j \\ \text{(demand and supply participation: 1,}\end{matrix} \\ \text{nonparticipation: 0)} \\ {p}_{i} \text{: a desired selling price of bid} j \\ ( supply side = + , demand side = - ) \\ {q}_{ij} \text{: a closed trade volume of resource 1 of user} \\ j \\ ( supply side = + , demand side = - ) \qquad ( 1 )$$

In formulas (1), the first formula is an objective function of optimization, and describes an optimization operation that aims at maximizing an economical index called the sum total of the differences between the desired demand and supply prices bid by respective users (surplus=social surplus) in the whole market. The second formula is a constraint formula required to attain the demand-and-supply balance of respective resources in the whole market. This formula is a typical one, and has a variation that maximizes an economical index such as the number of closed trades or the like in the whole market. For further details, please refer to the cited reference. As can be seen from this formula, the cited reference can determine winners (users who participate in trades), but cannot practically determine demand-and-supply relationships (so-called matching) among bids. For this reason, if some users don't conform to the winner determination, the whole demand-and-supply balance is lost, and all determinations must be temporarily canceled. In addition, since the cited reference makes the optimization operation that aims at maximizing the aforementioned economical index in the whole market, some users may suffer disbenefit, and it becomes harder to make the overall agreement about the determination. Hence, it is difficult to realize a flexible demand-and-supply intervening system that has discretions in decision making by the users: which settles demand and supply after agreement of the determination contents with respective users, which allows the users freely select a plurality of candidate plans or change the bid conditions by presenting such plans, and so forth.

### BRIEF SUMMARY OF THE INVENTION

In the demand-and-supply intervening system according to the present invention, each user who desires demand-and-supply intervention registers a set of a plurality of resources, and a combinatorial condition to be met between resources as unit data called an entry. Each user can set a complicated combinatorial condition such as a combination of demand-side resources and supply-side resources by hierarchically combining a condition that designates the quantity or ratio of resources, whose matching is to be achieved, or designates the lower limit value of the quantity or ratio of resources, whose matching is to be achieved.

The demand-and-supply intervening system designates a newly registered entry at the present moment or an entry registered by an important user as a base entry, and automatically finds a candidate group of entries, which include one or more base entries and all entries included in the group meet the combinatorial conditions, by a combinatorial optimization operation. As the combinatorial optimization operation to find the candidate group, a search method and a mixed integer programming are used.

When the search method is used, the combinatorial optimization operation defines a combinatorial condition penalty value indicating the degree of violation to the combinatorial condition designated for each entry, and minimizes the sum total of combinatorial condition penalty values of all the entries included in a candidate group as an objective function, thus finding the candidate group. In addition to these optimization conditions, the upper limit value of the number of entries included in the candidate group to be found may be constrained. As the method of the combinatorial optimization operation, a search method such as best-first search or the like is used.

When the mixed integer programming is used, the combinatorial condition specified in each entry is converted into the constraint formula automatically, and the constraint formula is solved as an optimization problem by using the mixed integer programming. As optimization criteria, a first optimization phase that automatically calculates the target value of a benefit of each user, and a second optimization phase that minimizes a penalty as the difference between this target value and actually obtained benefit, are executed.

### BRIEF DESCRIPTION OF THE SEVERAL VIEWS OF THE DRAWING

FIG. 1 is a schematic block diagram showing an example of the arrangement of a demand-and-supply intervening system according to the first embodiment;

FIG. 2 is a diagram showing an example when the demand-and-supply intervening system according to the embodiment of the present invention is applied to a power trading system;

FIG. 3 shows an example of an entry when the demand-and-supply intervening system according to the embodiment of the present invention is applied to the power trading system, together with respective entry examples;

FIG. 4 shows an example of an entry when the demand-and-supply intervening system according to the embodiment of the present invention is applied to the power trading system, together with respective entries;

FIG. 5 is a view for explaining a grouping function according to the embodiment of the present invention;

FIG. 6 is a view for explaining a grouping function according to the embodiment of the present invention;

FIG. 7 shows an example of a group generated by a grouping apparatus 1 when the demand-and-supply intervening system according to the embodiment of the present invention is applied to the power trading system;

FIG. 8 shows an example of a group generated by a grouping apparatus 1 when the demand-and-supply intervening system according to the embodiment of the present invention is applied to the power trading system;

FIG. 9 is a flowchart showing an overview of the processing operation of a candidate group determination unit 13 according to the embodiment of the present invention;

FIGS. 10A and 10B are views for explaining a determination method of matching in a temporary group;

FIG. 11 is a flowchart showing the flow when an search method called best-first search is used;

FIG. 12 is a flowchart showing the flow when an search method called best-first search is used;

FIG. 13 shows an example of a search tree;

FIG. 14 shows a matching result example;

FIG. 15 shows a matching result example;

FIGS. 16A and 16B show matching result example;

FIG. 17 shows a matching result example;

FIG. 18 is a schematic block diagram showing the arrangement of a whole demand-and-supply intervening system according to the second embodiment;

FIG. 19 is a flowchart showing the overall flow when the demand-and-supply intervening systems according to the first and second embodiments are used by a plurality of users;

FIG. 20 shows an example of a GUI upon browsing at level (4) in a power trading support system;

FIG. 21 shows an example of a GUI upon browsing at level (3) in a power trading support system;

FIG. 22 is a block diagram showing an example of the arrangement of a whole system according to the third embodiment; and

FIG. 23 is a block diagram showing an example of the arrangement of a whole system according to the fourth embodiment.

### DETAILED DESCRIPTION OF THE INVENTION

Preferred embodiments of the present invention will be described hereinafter with reference to the accompanying drawings.

### FIRST EMBODIMENT

The basic arrangement of a demand-and-supply intervening system according to the first embodiment of the present invention will be described first.

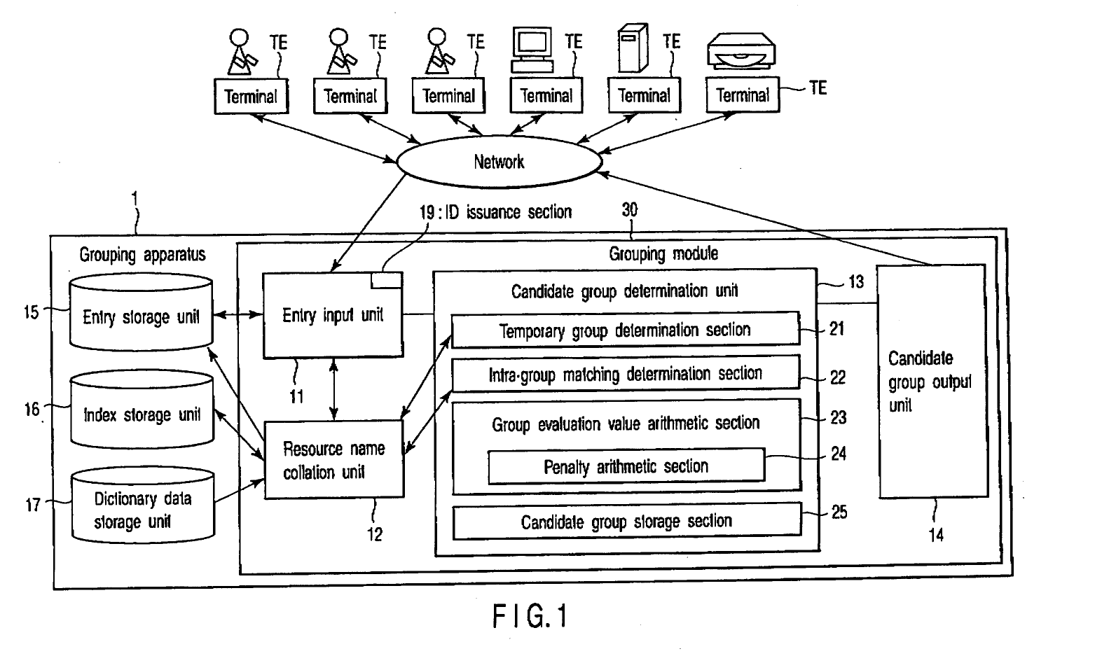

FIG. 1 is a schematic block diagram showing an example of the arrangement of a whole demand-and-supply intervening system according to the first embodiment. Referring to FIG. 1, a grouping apparatus 1 and a plurality of terminals TE are connected to a network. Each terminal TE establishes connection to the grouping apparatus 1 via the network, and transmits an entry. Note that “entry” is a basic unit of registration data of each user, which is required for the user to simultaneously register a plurality of resources and to designate and register a combinatorial condition to be met by the resources.

In FIG. 1, the grouping apparatus 1 comprises a grouping module 30, entry storage unit 15, index storage unit 16, and dictionary data storage unit 17. The grouping module 30 comprises an entry input unit 11, resource name collation unit 12, candidate group determination unit 13, and candidate group output unit 14. The candidate group determination unit 13 has a temporary group determination section 21, intra-group matching determination section 22, group evaluation value arithmetic section 23, penalty arithmetic section 24, and candidate group storage section 25.

The entry input unit 11 is an interface used when the grouping module 30 of the grouping apparatus 1 acquires an entry by accessing data and the like held on a versatile database (DB), data file, main memory, and the like (not shown). The entry input unit 11 receives an entry transmitted from each terminal connected to the network, and stores that entry in the entry storage unit 15. Note that the entry input unit 11 may acquire an entry by accessing each terminal TE connected to the network.

Each entry is input from, e.g., the user terminal to the entry input unit 11 of the grouping apparatus 1 via the network. Each entry is assigned an ID used for internal management by an ID issuance section 19.

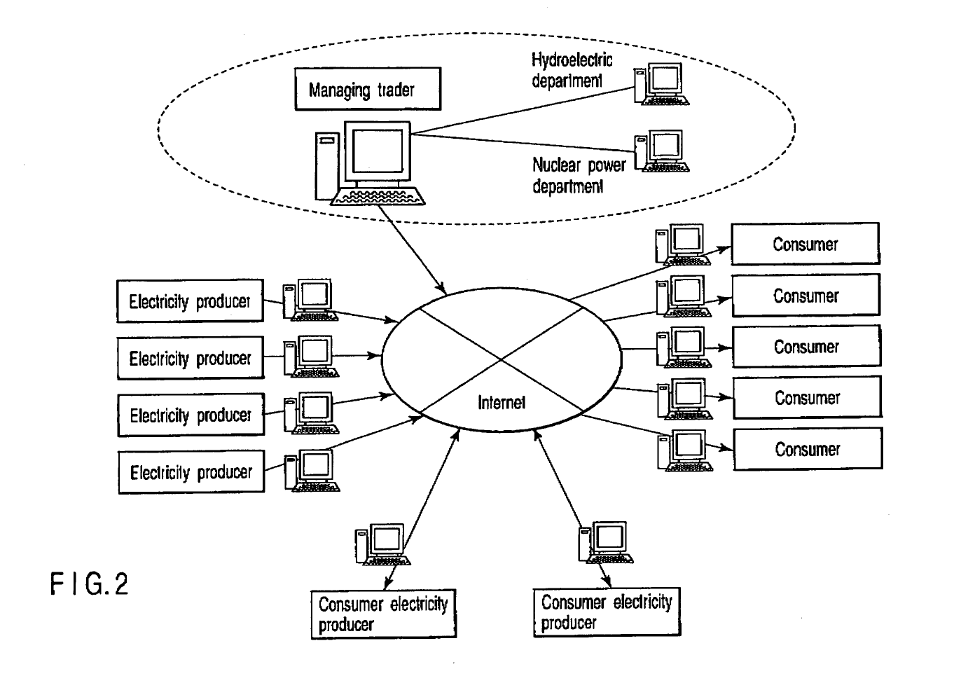

FIG. 2 shows an example when the demand-and-supply system according to the embodiment of the present invention is applied to a power trading support system. The grouping apparatus 1 is installed in, e.g., a server of a managing trader. Traders (electricity producer, consumer, consumer electricity producer) that may participate in trades have terminals used to exchange data with the grouping apparatus 1. Note that a single trader may use this demand-and-supply intervening system so as to keep an appropriate power balance among different departments with independent decision-making processes as well as external procurement.

As a method of transmitting a new entry from each terminal TE to the grouping apparatus 1, the following methods are used. In the first method, the terminal TE transmits an entry to the grouping apparatus 1 at the generation timing of the entry. In the second method, the entry input unit 11 of the grouping apparatus 1 periodically monitors the terminals TE, and issues an entry transmission request to the corresponding terminal TE if an entry is added. In this case, when a new entry is added or when a new grouping operation request is received from the terminal TE, the entry input unit 11 generates a trigger for operating the grouping module 30.

The candidate group determination unit 13 automatically finds a candidate group including a plurality of entries which can achieve matching that satisfies all combinatorial conditions designated for respective entries, as a partial set of an entry set input from the entry input unit 11.

Data to be described when the user registers an entry will be described below.

An entry as a basic unit of registration by each user will be explained first.

Each entry includes resource description data that defines resources as demand/supply objects, and combinatorial condition data that defines a combinatorial condition between resources included in one entry. The resource description data is defined by resource name data which specifies the type or name of a resource to be provided or requested, a demand/supply identification sign indicating if the user is the resource demand or supply side, and quantity data indicating the quantity of that resource as one set. When each entry is used for the purpose of intervening resource sales, desired price data that designates a desired unit price of a resource per unit quantity is added to the resource description data. In the following description, the demand/supply identification flag indicates a demand-side resource by the “−” sign, and a supply-side resource by the “+” sign. The resource name collation unit 12 determines based on resource name data if matching between the supply- and demand-side resources can be achieved between different entries. Note that “matching” is to determine a pair of supply- and demand-side resources between different entries.

“Combinatorial condition” is condition data used to designate the quantity or ratio of resources whose matching is to be achieved (e.g., matching of c out of k resources is to be achieved) or to designate the lower limit value of the quantity or ratio of resources whose matching is to be achieved. In the following description, a combinatorial condition C[=n]{ } indicates a condition that matching of n resources of those listed in { } is to be achieved, and a combinatorial condition {≧n]}{ } indicates a condition that matching of n or more resources of those listed in { } is to be achieved. In the following explanation, the resource description data describes “demand/supply identification flag+quantity t resource name+/desired price per unit quantity” in turn. When the quantity=1, a numerical value of the quantity is omitted, and when no desired price is designated, a numerical value of the desired price is omitted.

For example, if A, B, and C are resource names,
C[=50]{+100A\10}
indicates an entry which wants to provide 50 out of 100 units A for 10 per unit.
C[>10]{+20A, +30B, +5C}
indicates an entry which wants to provide a total of 10 units or more of 20 units, 30 units, and 5 units of A, B, and C. Also, an entry may include both provider- and consumer-side resources (e.g., a given resource is used as a material of another resource). For example,
C[=20]{−10A, +10B}
indicates an entry which wants to acquire 10 units of A and to provide 10 units of B at the same time.

Note that basic operators may be prepared for combinatorial conditions which are particularly frequently used so as to allow the user to make easy description. To this end, operation symbols such as logical product (AND), exclusive logical sum (XOR), ANY, and the like are preferably prepared. Note that “AND” indicates a combinatorial condition that wants to achieve matching of all resources listed in { }. “XOR” indicates a combinatorial condition that wants to achieve matching of only one of resources listed in { }. “ANY” indicates a combinatorial condition that does not designate any combinatorial condition for resources { } irrespective of the number of units of resources listed in { }, matching of which is achieved.

An entry may be expressed by a hierarchical structure (nested structure) including a plurality of combinatorial conditions so as to express a combinatorial condition for a more complicated relationship among resources. In this case, when viewed from a combinatorial condition that serves as a parent in the hierarchical structure, combinatorial conditions as children are equivalently handled as resource descriptions. When a combinatorial condition as a child is satisfied, it is handled in the same manner as that matching of resources is achieved. For example, when a request that “wants to provide product A by acquiring parts B and C or to provide E by acquiring parts B and D” is to be registered as an entry, it is expressed by a hierarchical entry which couples two combinatorial conditions AND{+A, −B, −C} and AND{+E, −B, −D} via the operator XOR. The following example indicates that either AND(+A, −B, −C} or AND{+E, −B, −D} need only be met.
XOR{AND{+A, −B, −C}, AND{+E, −B, −D}}
The following example indicates a case wherein if there are 100 sets of AND(+A, −B}, 50 or more sets are to be satisfied. More specifically, for example, this condition expresses a case wherein A and B are set to be equal quantities so as to produce A using B as a material.
C[≧50]{100AND{+A, −B}}

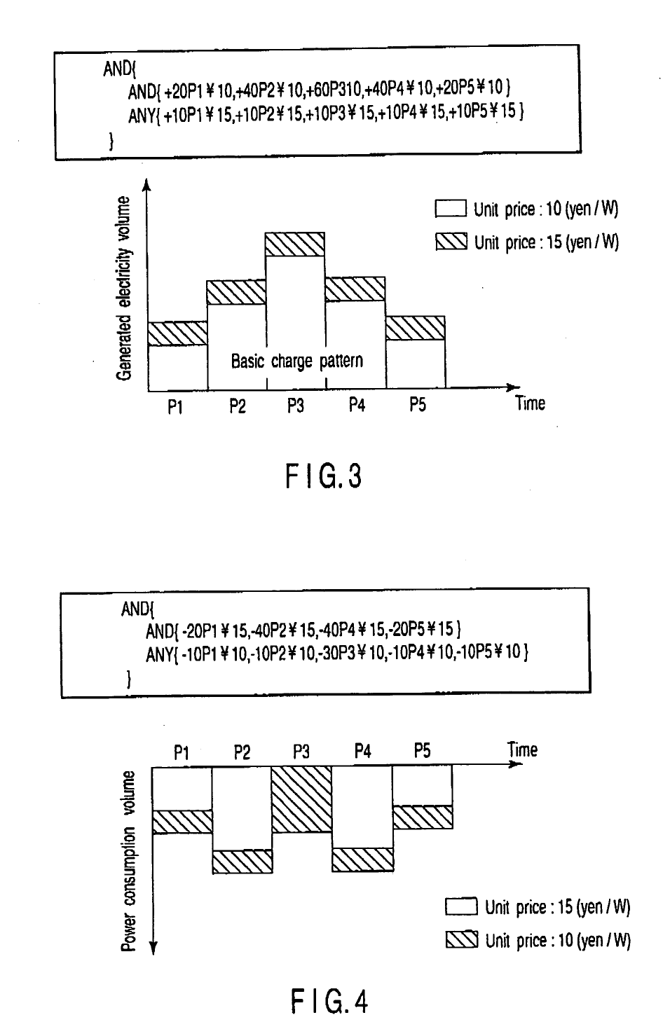

FIGS. 3 and 4 show an example of an entry when the demand-and-supply intervening system according to the embodiment of the present invention is applied to the power trading support system, together with respective entries. In an entry, P1, P2, and the like are resource names corresponding to electricity commodities in predetermined time bands. FIG. 3 shows an electricity producer, and FIG. 4 shows a consumer. In combinatorial conditions of two child entries, a portion designated by AND corresponds to a basic operation pattern determined by the characteristics of the generating facility or the job schedule of the consumer, and is to be traded for predetermined prices. Another portion bounded by ANY corresponds to an option which need not always be traded, but is traded only when a trade of the basic operation pattern is closed. In the embodiment of the present invention, even when the length of a time-series basic operation pattern differs for each entry or is separated, as shown in FIG. 4, such entries can be handled without any problems.

As a resource name, a method of listing a plurality of pieces of attribute information that designate a resource may be adopted in addition to a method of using a name that can uniquely identify a resource. For example, when the user describes an entry in a text format, he or she lists values corresponding to information that specifies a resource format (resource format name) and a plurality of pieces of attribute value information to describe:
(description format A, frame, stainless steel, size M)
   When resources to be registered have the same format, the format name is omitted, and only a plurality of pieces of attribute value information are simply designated like:
(frame, stainless steel, size M)

As attributes, various kinds of information that specify a resource such as color, shape, material, location, time, entity name, an ID number indicating an item, and the like are designated, and the types of attributes to be handled are not particularly limited. When the resource name collation unit 12 collates resource name data, if the format names match, it is determined that the following attributes correspond to each other. Hence, whether or not matching can be achieved can be determined by comparing the following attribute values. Even when attribute values are described using wildcard characters, it is determined in some cases that two resources match. For example, it is determined in some cases that matching between two resource names is achieved.
+{description format A, frame, stainless steel, *}
−(description format A, frame, *, size M}

In order to determine whether or not descriptions between two resources have identical attribute values, external dictionary data may be referred to, For example, it is determined based on the dictionary that “Kansai” includes “Osaka” between +[TV, Kansai} and −≡TV, Osaka}, and that matching can be achieved. Also, using an external processing module which is customized for a specific purpose, whether or not descriptions have identical attribute values may be determined based on, e.g., the magnitude relationship between numerical values. In this case, since the second resource values between +{TV, Day=5} and −{TV, Day=7} indicate days, and the designation day on the demand side is later than that on the supply side, it is determined in some cases that matching is achieved.

In case of the method of listing a plurality of pieces of attribute information, the ID issuance section 19 issues an ID for resource name management in the system to each resource name in each entry. As a result, when identical resource names are frequently used in different entries, data to be stored is reduced. Every time a new entry is input, the ID of a new resource name that appears in resource description data of the newly registered entry and those of the resource names used in the already stored entries are referred to, and determination results indicating resource names between which matching can be achieved are recorded as index information using data in a table format or the like.

Note that the resource description data and combinatorial condition data in an entry are premised on that an entry input by the user undergoes a pre-process of a parser or the like before the process of the grouping module 30. Therefore, the present invention is not limited to the aforementioned description method as long as these data include logically equivalent information volumes when they are passed to the grouping module 30 of the grouping apparatus 1. The pre-process of the parser is a process for parsing the resource description data, entry structure, and the like according to a grammar which is defined in advance, and is handled within the range of the conventional character string processing technique. The input method of an entry at the terminal and the output format of a candidate group in the candidate group output unit are not particularly limited. For example, the user may directly input an entry as text from the terminal, or may use an input GUI corresponding to a specific purpose (e.g., power trading support).

A grouping function according to the embodiment of the present invention will be described below.

In the following discussion, whether a resource is a divisible or indivisible resource is identified. “Divisible resource” means that a resource has no demand-and-supply basic unit quantity, and a demand-and-supply quantity can be handled as a continuous quantity. For example, electricity, oil, cloth, and the like are examples of divisible resources. A personal computer, display, printer, and the like are examples of indivisible resources.

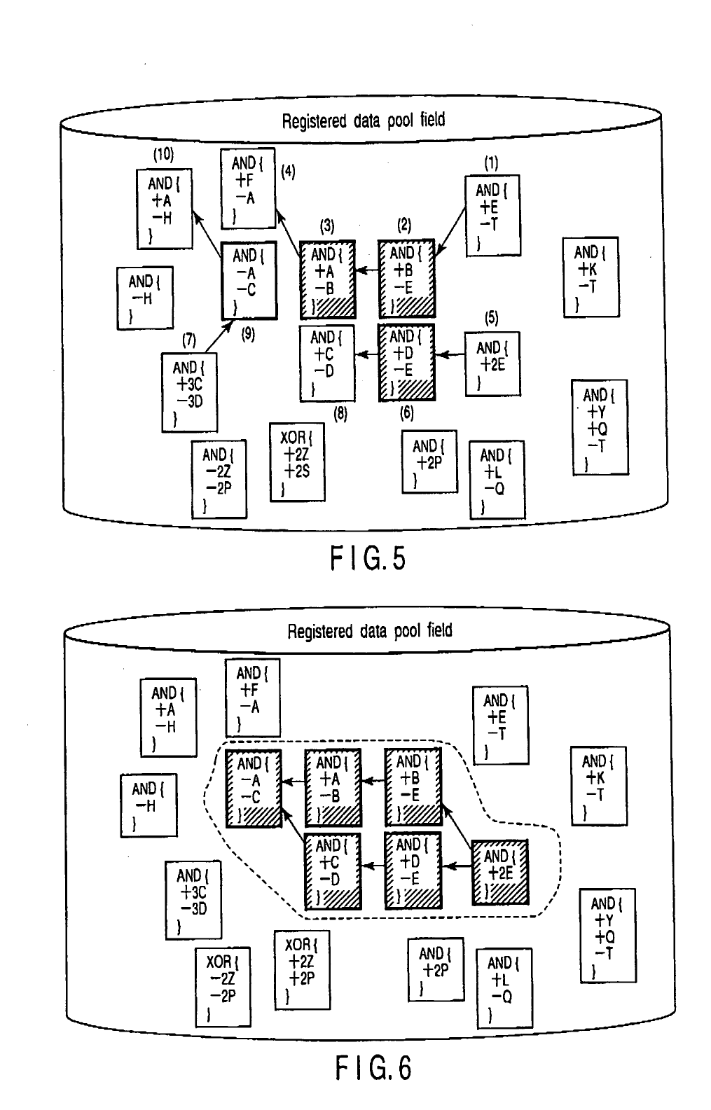

An explanation of the effect obtained upon grouping entries by the candidate group determination unit 13 will be given below using a simple example shown in FIGS. 5 and 6. Assuming that entries are registered in the demand-and-supply intervening system in the order of numbers attached in FIG. 5, if existing resources sequentially undergo matching in ascending order of number irrespective of combinatorial conditions, matching shown in FIG. 5 is settled (matching-achieved resources are tied via arrows). The second, third, sixth, and ninth registered entries satisfy combinatorial conditions, but the remaining first, fourth, fifth, seventh, eighth, and 10th entries do not satisfy combinatorial conditions. Under the influence of the presence of such entries, matching of the second, third, sixth, and ninth entries cannot be settled. FIG. 6 shows an example of a candidate group found by the candidate group determination unit 13 and matching upon registration of the ninth entry when entries are registered in the same order as in FIG. 5. A candidate group which includes the ninth entry as a base point, and in which combinatorial conditions of all entries included in the group are satisfied is found by the combinatorial operation. The entry which serves as the base point is designated as an entry, which must always be included in the candidate group, and one or more such entries are always designated. The base point is a newly registered entry. Alternatively, in case of the fourth embodiment in which an arithmetic operation of the grouping apparatus 1 is independently processed for each user and details of which will be described later, an entry registered by a corresponding user is set as a base entry. Alternatively, the most important entry registered by a particularly important user is often always set as a base entry. Furthermore, a plurality of base entries are often designated. For example, two entries, i.e., an entry registered by the important user and a newly registered entry are set as base entries in some cases.

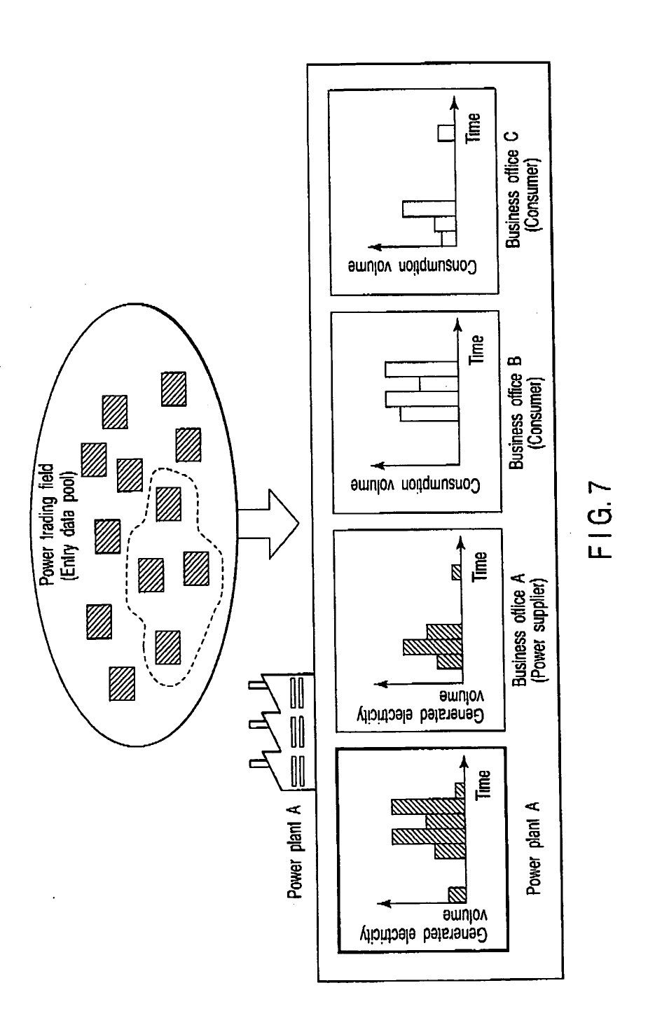

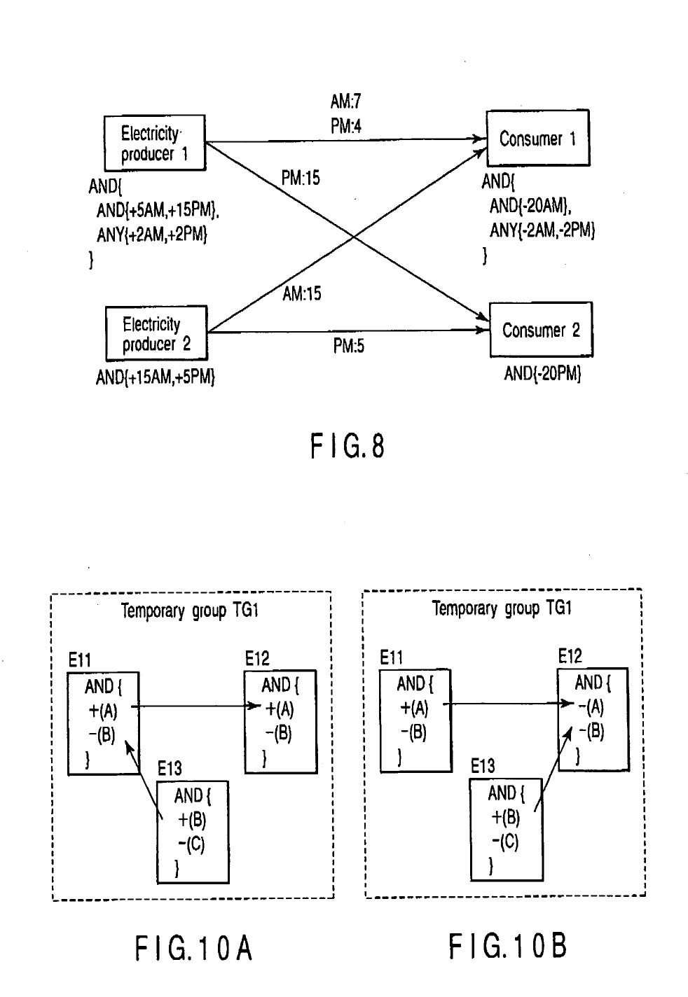

FIGS. 7 and 8 show examples of a group generated by the grouping apparatus 1 when the demand-and-supply intervening system according to the present invention is applied to the power trading support system. In the example shown in FIG. 7, each trader registers entries as a time-series pattern, and the grouping apparatus 1 finds a candidate group which includes a base entry registered by trader A, and in which the generated electricity volume and consumption volume become nearly uniform in all time bands. FIG. 8 shows an example of corresponding a description of an entry with a group created by the grouping apparatus 1. AM and PM are respectively resource names, which correspond to AM and PM electric power volumes, respectively. Numerals attached to arrows indicate matching-achieved electric power volumes. In this case, if a minimum unit of the electric power volume is determined upon trading, such resource is an indivisible resource; otherwise, it is a divisible resource.

The combinatorial optimization operation used to generate a candidate group includes two different criteria: “optimization for base entry” and optimization for all entries included in candidate group”. Examples of the combinatorial optimization operation are described by:

$$\begin{matrix} max {\sum }_{K ∈ BY} {\sum }_{i ∈ Ik} {\sum }_{j ∈ I} wijyij \\ such that \\ Zi = {\sum }_{j ∈ I} yij \\ xk = fk ( \overline{Z} k ) k ∈ B \\ xk = 1 ∀ k ∈ BY \\ where I \text{: a set of resource} \\ {I}_{k} \text{: a set of resources that belong to entry} k \\ B \text{: a set of entries} \\ BY \text{: a set of base entries;} BY ⋐ B \\ {x}_{k} \text{: a decision variable of entry} k \\ \text{(demand and supply participation: 1,} \\ \text{nonparticipation: 0)} \\ {y}_{ij} \text{: a matching decision variable between} \\ resources i and j \\ \text{(matching achieved: 1, not achieved: 0)} \\ {w}_{ij} \text{: a matching weight between resources} i and j \\ \overline{{z}_{k}} \text{: a decision variable vector of a resource} \\ \text{which belongs to entry} k \\ {f}_{k0} \text{: a combinatorial condition of entry} k & ( 2 ) \\ min {\sum }_{κ ∈ B} xk ( Uk - {\sum }_{i ∈ Ik} {\sum }_{j ∈ I} wijyij ) \\ such that \\ Zi = {\sum }_{j ∈ I} yij \\ xk = fk ( \overline{Z} k ) k ∈ B \\ xk = 1 ∀ k ∈ BY \\ where I \text{: a set of resource} \\ {I}_{k} \text{:} \text{a set of resources that belong to entry} k \\ B \text{: a set of entries} \\ BY \text{: a set of base entries;} BY ⋐ B \\ {x}_{k} \text{: a decision variable of entry} k \\ \text{(demand and supply participation: 1,} \\ \text{nonparticipation: 0)} \\ {y}_{ij} \text{: a matching decision variable between} \\ resources i and j \\ \text{(matching achieved: 1, not achieved: 0)} \\ {w}_{ij} \text{: a matching weight between resources} i and j \\ \overline{{z}_{k}} \text{: a decision variable vector of a resource} \\ \text{which belongs to entry} k \\ {f}_{k0} \text{: a combinatorial condition of entry} k \\ {u}_{k} \text{: a target value set for entry} k & ( 3 )\end{matrix}$$

In formulas (2) and (3) which will be described in the second embodiment in detail, the first formula is an objective function of optimization for a base entry, and makes an optimization operation that aims at maximizing the sum of matching weights associated with resources included in the base entry. For example, if desired selling and purchasing prices are set for respective resources, the difference between the desired selling and purchasing prices between matching-achieved resources is set as a matching weight, thus reflecting a trading benefit of the user who registers the entry (on the assumption that some amount of the difference is refunded to the user). The second formula is a constraint formula required for one-to-one matching between resources. The third formula is a constraint formula of the combinatorial conditions, and the fourth formula is a constraint formula of a base entry included in the candidate group.

In formulas (3), the first formula is an objective function of optimization for all entries included in the candidate group. A value as a difference obtained when the sum of matching weights associated with resources included in each entry dips from the target value set for that entry is defined as a penalty value, and an optimization operation that aims at minimizing this penalty value is made. The second and third formulas have the same meanings as those in formulas (2). In order to facilitate agreement after the candidate group is found, a condition that the number of entries included in the group is equal to or smaller than a predetermined maximum value is often added.

According to setting of the optimization object of formulas (1), the user as a base point is a Managing trader, a parent company of a business group, or the like, and demand-and-supply intervention that gives top priority to the benefit of the base point user, and does not consider other users except that combinatorial conditions are satisfied is made.

According to setting of the optimization object of formulas (2), demand-and-supply intervention so that each profit objective of users other than a base point included in the candidate group is considered, and the effect of reducing the number or entries included in the candidate group and high evaluation criterion for all entries included in the candidate group can be achieved at the same time. For this reason, it is expected to easily obtain agreement of respective users with the candidate group.

The combinatorial optimization operation (formulas (1) and (2)) used to generate a candidate group in the demand-and-supply intervening system of the present invention can obtain an optimal solution (candidate group) that strictly keeps constraints associated with combinatorial conditions using an operations research method called mixed integer programming. However, as the problem scale increases, since it may become harder to obtain an optimal solution, a method of quickly obtaining a quasi-optimal solution using a search method will be explained in the first embodiment.

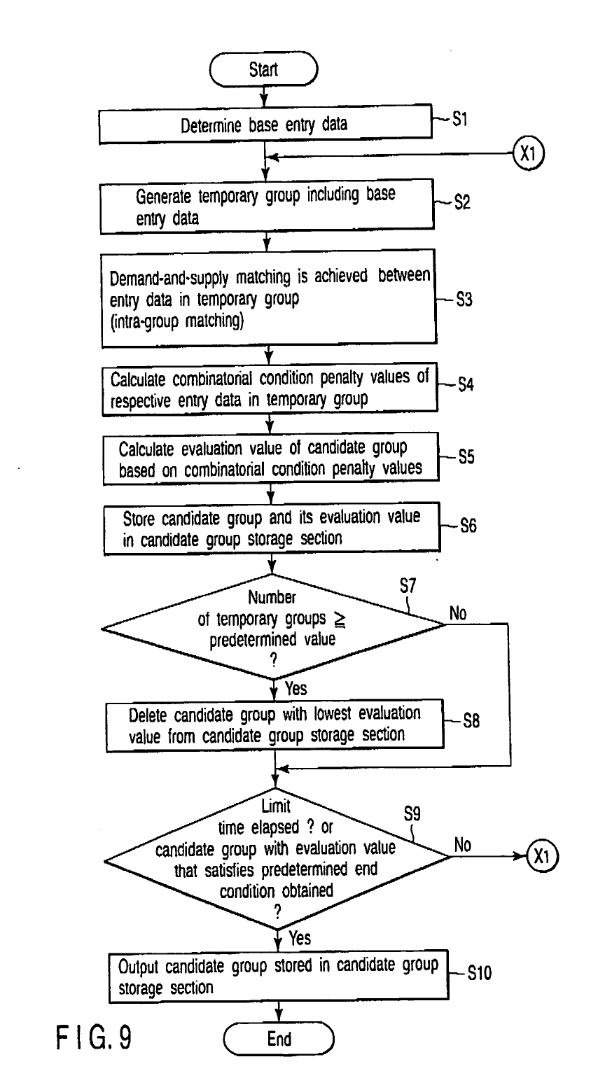

An overview of the processing operation of the candidate group determination unit 13 according to the embodiment of the present invention will be described below with reference to the flowchart shown in FIG. 9. The processing operation for determining a candidate group is executed in response to registration of a new entry as a trigger or a new grouping operation request from the user.

An entry that serves as a base point is designated (step S1). A temporary group determination section 21 generates a temporary group including the base entry (step S2).

The intra-group matching determination section 22 executes intra-group matching that limits matching targets to entries in the temporary group (step S3). In this step, resources having a demand-and-supply relationship (matching is achieved) between entries in the temporary group are determined. The combinatorial condition penalty arithmetic section 24 calculates combinatorial condition penalty values of respective entries on the basis of the matching results of entries in the temporary group (step S4).

The group evaluation value arithmetic section 23 calculates a group evaluation value of the whole temporary group on the basis of the combinatorial condition penalty values (step S5), and temporarily stores a candidate group in the candidate group storage unit 25 together with the evaluation value (step S6).

If the number of temporarily stored temporary groups exceeds a predetermined value (NO in step 37), the flow jumps to step S9. Otherwise (YES in step S7), the temporary group with the lowest evaluation value is deleted from the candidate group storage unit 25, and the flow advances to step S9 (step 38).

If a time elapsed after the beginning of the process has not exceeded a predetermined limit time yet, or if the evaluation value of the obtained temporary group does not satisfy a predetermined end condition (NO in step S9), the flow returns to step S2 to generate another temporary group which is different from those which are generated so far, thus repeating steps S3 to S9. If it is determined in step S9 that the limit time has elapsed or a temporary group with an evaluation value that satisfies the end condition is obtained (YES in step S9), the temporary group stored in the candidate group storage section 25 is output from the candidate group output unit 14 as a candidate group (step S10).

The combinatorial condition penalty is a value used as a guideline of refusal of temporary solutions during search upon determining a candidate group that satisfies combinatorial conditions designated for respective entries, and intra-group matching by the search method. The optimization operation based on the search method aims at obtaining a candidate group which includes a base entry and in which the penalty values of all entries included in the group are zero.

An example of a combinatorial condition penalty operation method will be described below. Let ei (i=1, 2, . . . , m) be each resource in entry e, and ei (i=m+1, . . . , n) be each combinatorial condition while examining a general entry which has a plurality of combinatorial conditions that form a nested structure. A variable Xi is defined as 0 or 1. As for each resource ei (i≦m), if matching of that resource is achieved in a temporary group, Xi=1; otherwise, Xi=0. As for each combinatorial condition ei (i≧m+1), if a designated constraint is satisfied, Xi=1: otherwise, Xi=0. A combinatorial condition penalty of an entry is the sum total of penalty values Pi calculated for respective combinatorial conditions in the entry. The penalty value Pi of each combinatorial condition ei is calculated based on the sum of variables Xj of child combinatorial conditions of ei in the hierarchical structure and resources.

Let Ci be a set of children ej (j=1, 2, 3, . . . ) of combinatorial condition ei. In order to express a difference between a target value ki of the number of children that want to achieve matching, and the sum of variables Xj of child combinatorial conditions of ei in the hierarchical structure and resources by a value normalized between “−1.0” to “1.0”, variable D is calculated by:

$$D = ( {\sum }_{j ∈ Ci} {X}_{j} - Ki ) / \vert Ci \vert \\ ( a ) A combinatorial condition is C [ \geq Ki ] \{ \} \\ Pi = min ( 0 , D ) \\ ( b ) A combinatorial condition is C [ = Ki ] \{ \} \\ Pi = min ( - D , D ) \\ ( c ) A combinatorial condition is ANY \{ \} \\ Pi = 0 \\ Combinatorial condition penalty P = {\sum }_{i \geq m + 1} Pi \qquad ( 4 )$$

The group evaluation value is used as that of the whole temporary group by adding up a value obtained by inverting the sign of the objective function of formulas (2) or the value of the objective function of formulas (3) to the sum total of the combinatorial condition penalty values.

In step S2 in FIG. 9, a plurality of different temporary groups are generated until the processing time reaches the limit time or a candidate group with the evaluation value which satisfies the end condition is obtained. Upon generation of a temporary group, another temporary group for which some arithmetic operations have already been made or stored candidate groups may be modified and used during the arithmetic operations. For example, a process for adding a new entry, a process for deleting an entry, a process for combining a plurality of temporary groups into one temporary group, or a process for dividing one temporary group into a plurality of groups may be done.

In step S3 in FIG. 9, resources which have a demand-and-supply relationship between entries included in the temporary group are practically associated with each other to determine matching in the temporary group. Normally, the demand-and-supply relationship of resources between entries, i.e., which of supply- and demand-side resources are to be associated with each other, cannot be uniquely determined in the group. The evaluation values of entries and that of the temporary group may change depending on the intra-group matching method. For example, in FIG. 10, an arrow which extends from resource description data which represents a supply resource to that which represents a demand resource expresses matching (association) between resources having a demand-and-supply relationship. In this case, there are a plurality of patterns of a method of determining intra-group matching even in a single temporary group TGI including entries (E11 to E13). For this reason, the grouping apparatus 1 sets priority to resources in each entry and entries in the group in accordance with specific rules, and uniquely determines intra-group matching using this priority. An example of the priority setting method will be described later. Upon generating a new temporary group by reusing an old temporary group, already matched portions in the old temporary group are inhibited from being changed, thus preventing a large change in intra-group matching at a time. An example of the intra-group matching determination method will be described later.

When additional data that designates the quantities of resources is appended to the resource description data, it is taken to mean that there are a plurality of identical resources, and identical combinatorial conditions are defined for them. For this reason, the penalty value of an entry remains unchanged irrespective of the matching method between these resources.

As the intra-group matching determination method, a method of adopting one with the best group evaluation value of all matching patterns (in this case, intra-group matching with the best evaluation value is obtained by repeating steps S3 to S6 while changing matching resources) or a method of uniquely determining intra-group matching according to predetermined rules may be adopted.

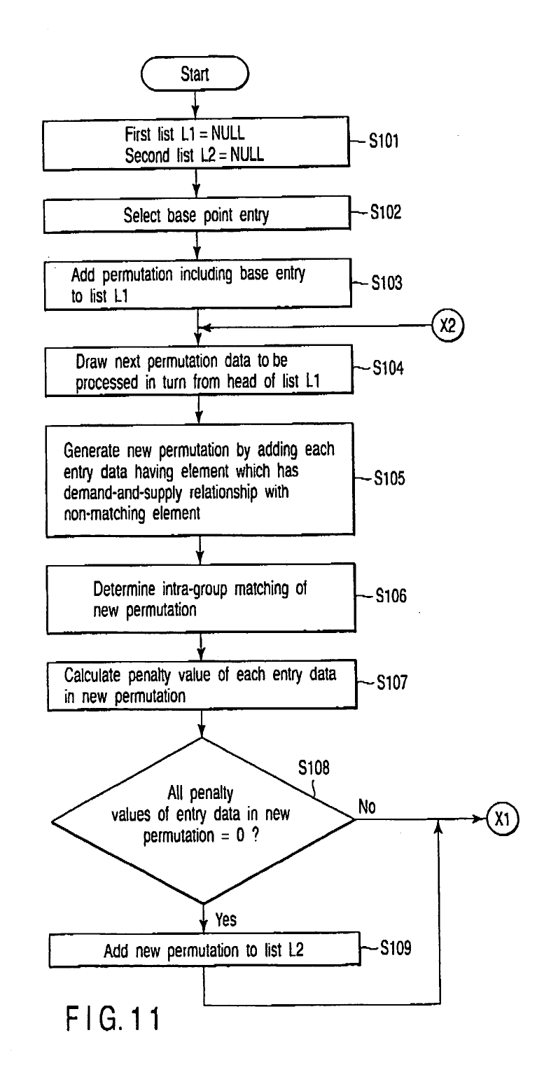

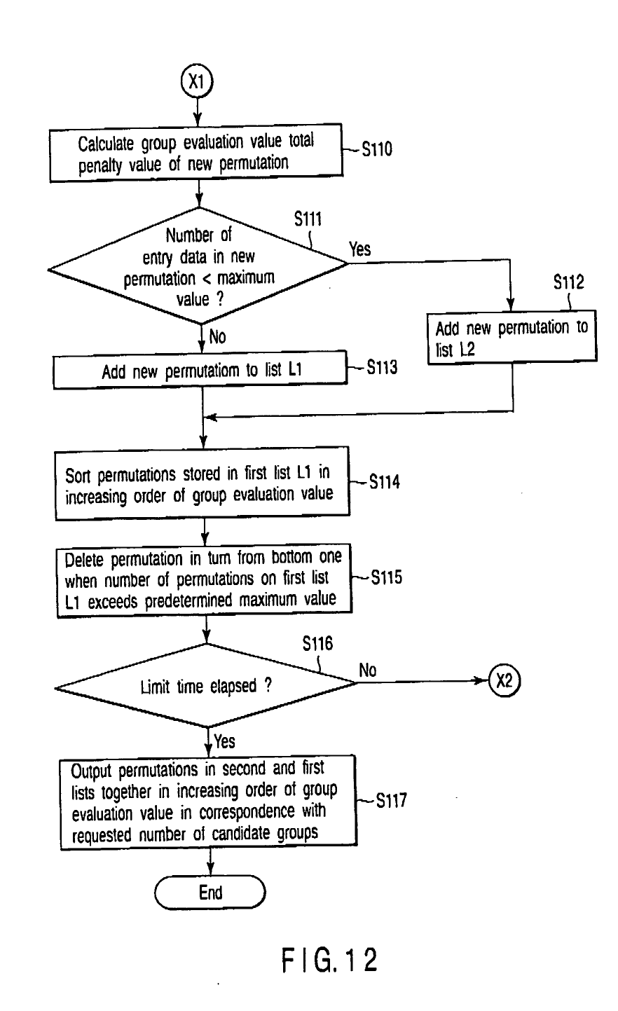

A case will be explained using a simple example with reference to the flowcharts shown in FIGS. 11 and 12 wherein a search method called best-first search is applied.

For example, a solving method that repeats a process for sequentially adding an entry to a base entry, checking matching between these entries in a predetermined sequence, and then calculating a group evaluation value, and searches for intra-group matching while gradually increasing the temporary group may be used as an example. The search object is the order of adding entries that can undergo matching to the temporary group and, in other words, it is a permutation of entries to have the base entry as the head. A maximum size of the number of permutations to be recorded in the list is determined in advance, and when the number of permutations to be recorded in the list exceeds this maximum size, a permutation is deleted in turn from that with a lowest evaluation value. The penalty values are calculated for entries in each permutation, all matching weights are set to be zero in this example, and the sum total of combinatorial condition penalty values is used as a group evaluation value.

In this case, the following five entries EN1 to EN5 are stored in the entry storage unit 15. This corresponds to a simple description of entries in power trading support, as shown in FIG. 8. In this case, no selling unit price is set. The entries EN1 to EN5 are registered in the order named.

```
EN1:
  AND{
    AND{+5AM,+15PM},
    ANY{+2AM,+2PM}
  }
EN2:
  AND{
    AND{−20AM},
    ANY{−2AM,−2PM}
  }
EN3:
  AND{+15AM,+5PM}
EN4:
  AND{+15AM,−2PM}
EN5:
  AND{+2AM,+20PM}
```

Assume that a new entry EN6: AND{−20PM} is input from the entry input unit 11.

The temporary group determination section 21 empties first and second lists L1 and L2 by initializing them (step S101). The list L1 is prepared to temporarily store an intermediate search result, and the list L2 is prepared to temporarily store a temporary group while continuing search if a temporary group that can be used as a candidate group to be output is found.

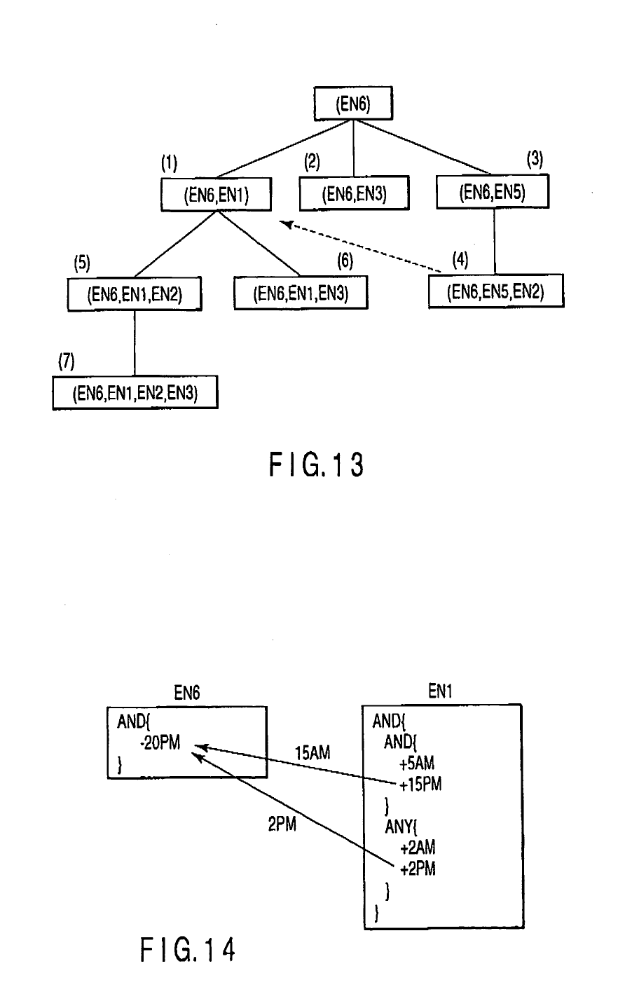

The entry EN6 is set as a base entry (step S102), and is recorded in the first list L1 (step S103). The entries EN1, EN3, and EN5 as entries having resources (+PM) that allow matching are respectively added to this base entry (step S104) to generate permutations (EN6, EN1), (EN6, EN3), and (EN6, EN5) like (1) to (3) in a search tree shown in FIG. 13 (step S105). When a plurality of base entries are designated, a permutation including the base entries is generated first, and the search process then starts. For example, when three entries EN6, EN1, and EN3 are designated as base entries, after matching is executed in the order of:
(1) intra-group matching of a permutation (EN6, EN1); and
(2) intra-group matching of a permutation (EN6, EN1, EN3),
   a search starts from the permutation (EN6, EN1, EN3).

The intra-group matching determination section 22 associates resources having a demand-and-supply relationship with each other for the generated permutations (step S106). The intra-group matching determination section 22 determines matching between resources whose matching is achieved in each permutation, and stores resources whose matching is not achieved yet for respective permutations. When a plurality of resources correspond to a resource name like in this embodiment, the number of matching-achieved resources is subtracted from the quantity designated for resources and the number of resources whose matching is not achieved yet is stored upon associating resources having a demand-and-supply relationship. For example, in case of the permutation (EN6, EN1), as shown in FIG. 14, “−20PM” of EN6 is associated with “+15PM” under the AND condition and “+2PM” under the ANY condition of EN1. In FIG. 14, each arrow corresponds to the demand-and-supply direction, and a resource name and numerical value appended to the arrow correspond to the matching-achieved resource name and quantity. Resources whose matching is not achieved yet are “−3PM” of EN6, “+5AM” of EN1, and those which are designated by ANY.

The penalty arithmetic section 24 calculates combinatorial condition penalty values of entries in the respective permutations (step S107). If all the penalty values of entries of a given permutation are zero, since that permutation can be one of candidate groups to be obtained (step S108), that permutation is stored in the list L2 (step S109).

In this case, since the two permutations are not such permutation, the flow advances to step S110 to calculate the sum total of penalty values of entries included in a temporary group (permutation) using formulas (4) for each permutation. For example, arithmetic operations are made taking the permutation (EN6, EN1) as an example. Since EN6 includes one AND condition, and matching of a total of 17 units of 20 units of resources as a child of that condition is achieved, a penalty value is −(20−17)/20=−0.15. EN1 includes two AND conditions, but the AND condition of the top layer is ignored since it is satisfied all the time if only the lower AND condition is satisfied. Since matching of 15 units of 20 units of resources as a child of the lower AND condition is achieved, the penalty value is −5/20=−0.25. Hence, the penalty sum total for the permutation (EN6, EN1) is −0.4. The calculation results of the group evaluation values of other permutations are as follows.
Permutation (EN6, EN1) penalty value: −0.4
Permutation (EN6, EN3) penalty value: −0.75−0.75=−1.5
Permutation (EN6, EN5) penalty value: −0.0−0.2=−0.2

Since the number of entries in each of these three permutations is smaller than the predetermined maximum value (5 in this case) (step S111), these three permutations are added to the first list L1 (step S112), and the permutations recorded in the first list L1 are sorted in descending order of group evaluation value (step S114). If the number of permutations on the first list L1 exceeds the predetermined maximum value, a permutation is deleted in turn from the bottom one (in descending order of penalty value) (step S115). Furthermore, if a time elapsed after the beginning of the process does not reach a predetermined limit time (step S116), the flow returns to step S104.

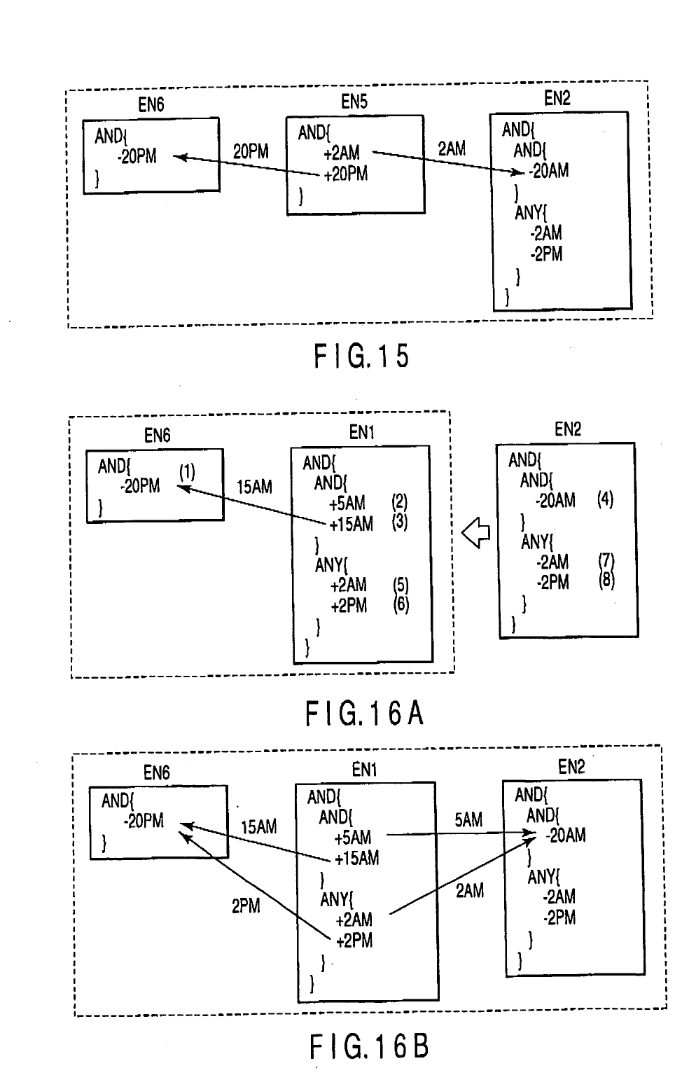

In step S104, the next permutation to be processed is extracted in turn from the top of the first list L1. That is, another entry is added to the permutation (EN6, EN5) with the largest group evaluation value. Since “+2AM” of EN5 still remains, an entry that allows matching is only the entry EN2 including a resource (−AM), and a permutation (EN6, EN5, EN2) is generated, as indicated by (4) in FIG. 13 (step S105). The matching result of the permutation (EN6, EN5, EN2) is as shown in FIG. 15.

Note that a resource that has once undergone matching in a temporary group does not change its matching partner, and only a resource which does not undergo matching is considered as a matching target in principle, thus quickly and uniquely determining matching. However, since a resource which is designated by ANY in a combinatorial condition has no combinatorial condition, it is excluded, and matching of a resource designated by ANY is temporarily disconnected in step S105. If a plurality of matching methods are available in a single permutation, matching priority is determined according to the following general rules so as to quickly and uniquely determine matching for a permutation for an advantageous base entry, and resources that allow matching are associated in turn from those which have higher priority.

(1) Matching is preferentially made from resources of an entry which is added to a permutation first.

(2) When there are a plurality of identical resources in an entry, matching is made in accordance with the predetermined priority order of resources in that entry. A resource whose combinatorial condition is designated by ANY has a lowest priority, and a resource whose combinatorial condition is designated by C{≧n}{ } or C[=n]{ } has a highest priority until its combinatorial condition is satisfied. More specifically, a resource whose combinatorial condition is designated by AND always has the highest priority.

For example, when EN2 is added to the permutation (EN6, EN1), as shown in FIG. 16(a), the priority order is the order of attached numbers, and matching is determined in turn from −5PM of EN6, thus obtaining the intra-group matching result shown in FIG. 16(b).

Likewise, the penalty values of respective entries and group evaluation value are calculated for the permutation (EN6, EN5, EN2) (steps S106 to S110). This result is as follows.
Permutation penalty value: −0.0−0.0−0.9=−0.9 (EN6, EN5, EN2)

The number of entries in these permutations is smaller than the predetermined maximum value (=5), and these permutations are registered in the first list L1 (step S112).

As a result of sorting the permutations registered in the first list L1 in descending order of group evaluation value in step S114, a back track occurs. More specifically, since the permutation (EN6, EN1) which is generated and is saved in the first list L1 earlier has a higher group evaluation value than that of the permutation (EN6, EN5, EN2), the permutation (EN6, EN1) is set at the head of the first list L1. Therefore, the same process is repeated for this permutation (EN6, EN1) as that to be processed, in step S104 and the subsequent steps.

Since the permutation (EN6, EN1) allows matching with the entry EN2 or EN3 including a resource (+PM) or (−AM), permutations (EN6, EN1, EN2) and (EN6, EN1, EN3) are generated, as indicated by (5) and (6) in FIG. 13 (step S105). Likewise, the penalty values of entries and group evaluation values are calculated (steps S106 to S110). The calculation results are as follows.
Permutation (EN6, EN1, EN2) penalty value: −0.8
Permutation (EN6, EN1, EN3) penalty value: −1.0

In step S114, another entry is added to the permutation (EN6, EN1, EN2) with the highest group evaluation value of those registered in the first list L1 to generate a permutation (EN6, EN1, EN2, EN3), as indicated by (7) in FIG. 13. Since the penalty values of all the entries EN6, EN1, EN2, and EN3 are zero (step S108), the search process ends (step S109).

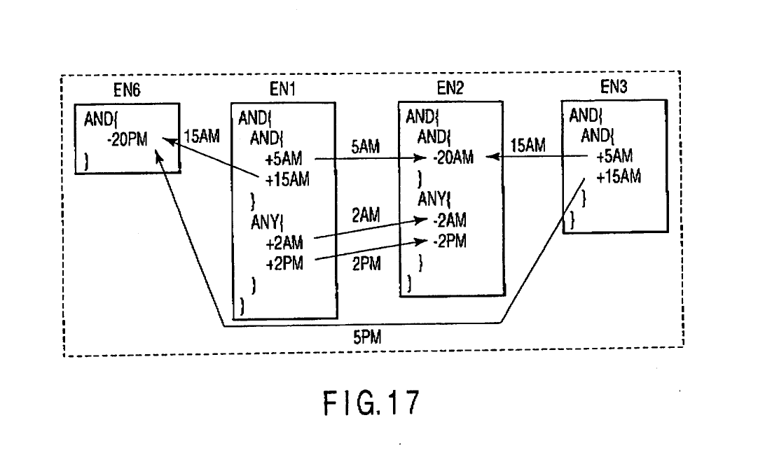

FIG. 17 shows intra-group matching of the permcutation (EN6, EN1, EN2, EN3).

### SECOND EMBODIMENT

In the first embodiment, when the user simultaneously registers a plurality of resources and designates a constraint to be satisfied between resources, intervention that not only satisfies the constraint of only one specific user but also considers the constraint of the partner at the same time is made. For this reason, according to the first embodiment, in the example of the power trading support system, constraints which consider the characteristics in terms of operation of generating facilities, power consumption patterns required for business, and the like, which cannot be handled by a conventional, simple demand-and-supply intervening system, can be generally handled. In the second embodiment, an optimum calculation method to find the candidate group is solved by the mixed integer programming, not the search method.

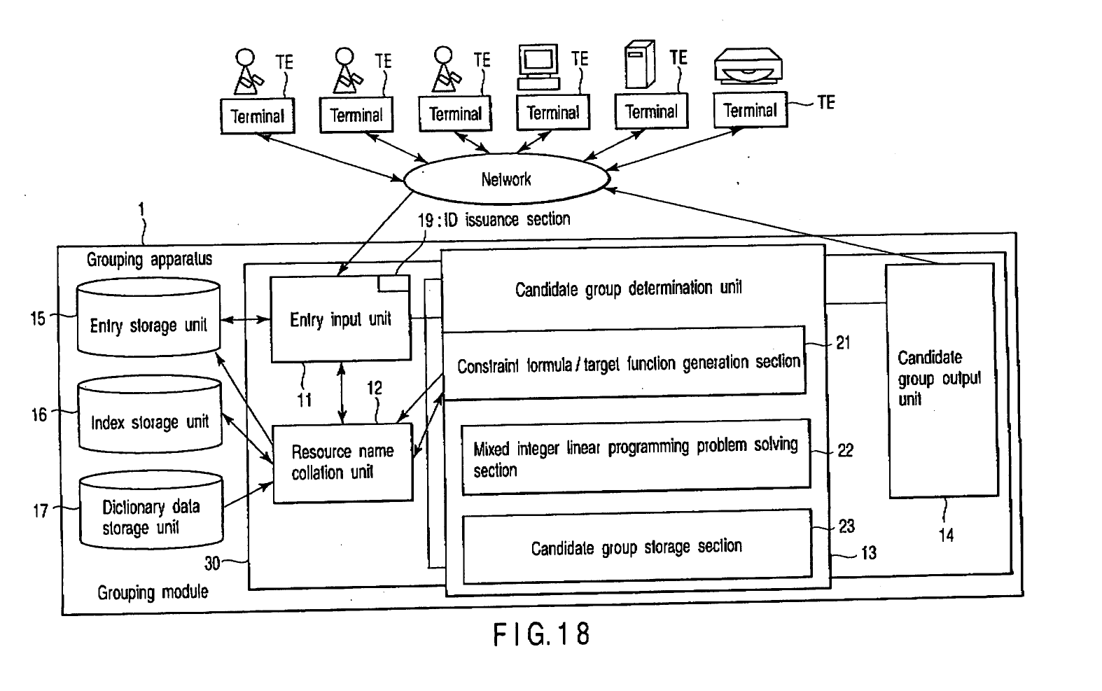

FIG. 18 is a schematic block diagram showing an example of the arrangement of the overall demand-and-supply intervening system according to the second embodiment. The same reference numerals in FIG. 18 denote the same parts as in FIG. 1, and a detailed description thereof will be omitted. In the arrangement shown in FIG. 18, the arrangement of the candidate group determination unit 13 is different from that shown in FIG. 1. That is, the candidate group determination unit 13 has a constraint formula/objective function generation section 26, mixed integer linear programming problem solving section 27, and candidate group storage section 25.

The mixed integer programming problem solving means retrieves and outputs one of sets of variables that maximize or minimize the objective function value and an optimal value at that time within the range in which constraints given by integer constraints of linear inequalities and variables are satisfied. If no such optimal solution is found or a solution is unbounded, a message that advises accordingly is output. Furthermore, a time limitation may be set to return the best value obtained within that limit time. As the mixed integer linear programming problem solving method, a method that combines a simplex method, branch-and-bound method, cutting method, and the like as linear programming problem solving methods is known. As high-speed, versatile mixed integer programming problem solving means using these methods, software called CPLEX developed by ILOG, Inc. is well-known (see http://www.ilog.com/products/cplex).

The demand-and-supply intervening system of this embodiment is characterized in that the combinatorial optimization operation required to generate a candidate group has two different optimization criteria, i.e., if maximization of a utility value of a base entry is defined as an objective function or minimization of a difference from a target value of each individual entry is defined as an objective function.

The utility value of each individual entry is a value that numerically expresses the satisfaction level obtained as a result of demand-and-supply matching of each entry. The satisfaction level of the user who registers an entry becomes higher with an increase in this value.

The configurations of optimization problems using the two different optimization criteria are respectively described by:

$$\begin{matrix}( Objective function \text{:} {O}_{1} ) max Ub \\ ( Definition of utility value \text{:} {C}_{U} ) Ub = {\sum }_{i ∈ Ib} {\sum }_{j ∈ MIi} wijyij \\ ( Participation condition of base entry \text{:} {C}_{b} ) xb = 1 \\ ( Demand \text{-} and \text{-} supply constraint of resource \text{:} {C}_{M} ) \\ mizi \leq {\sum }_{j ∈ MIi} yij \leq Mizi ( or mizi = {\sum }_{j ∈ MIi} yij ) ∀ i ∈ I \\ ( Combinatorial condition of resource \text{:} {C}_{L} ) xk = fk ( zk ) \\ ∀ k ∈ E \\ ( Integer constraint of x and z \text{:} {C}_{X} ) xk , zi ∈ \{ 0 , 1 \} \\ ( Non \text{-} negative constraint of y \text{:} {C}_{Y1} ) {y}_{ij} \geq 0 ( in case of \\ divisible resource ) \\ ( Non \text{-} negative integer constant of y \text{:} {C}_{Y2} ) {y}_{ij} ∈ \{ 0 , 1 , \\ 2 , … \} ( in case of indivisible resource ) & ( 5 ) \\ ( Objective function \text{:} {O}_{2} ) min {\sum }_{kCE} xk ( {U}_{k}^{*} - {U}_{k} ) \\ ( = {\sum }_{k ∈ E} ( {xkU}_{k}^{*} - {U}_{k} ) ) \\ ( Definition of utility value \text{:} {C}_{U} ) Uk = {\sum }_{iCIb} {\sum }_{j ∈ MIi} wijyij \\ ∀ i ∈ I \\ ( Participation condition of base entry \text{:} {C}_{b} ) xb = 1 \\ ( Demand \text{-} and \text{-} supply constraint of resource \text{:} {C}_{M} ) \\ mizi \leq {\sum }_{j ∈ MIi} yij \leq Mizi ( or mizi = {\sum }_{jCMIi} yij ) ∀ i ∈ I \\ ( Combinatorial condition of resource \text{:} {C}_{L} ) xk = fk ( zk ) \\ ∀ k ∈ E \\ ( Integer constraint of x and z \text{:} {C}_{X} ) xk , zi ∈ \{ 0 , 1 \} \\ ( Non \text{-} negative constraint of y \text{:} {C}_{Y1} ) {y}_{ij} \geq 0 ( in case of \\ divisible resource ) \\ ( Non \text{-} negative integer constant of y \text{:} {C}_{Y2} ) {y}_{ij} ∈ \{ 0 , 1 , \\ 2 , … \} ( in case of indivisible resource ) & ( 6 )\end{matrix}$$

In these formulas, set definitions are;
I: a set of resources
Iₖ: a set of resources that belong to entry k
MIᵢ; a set of resources that allow matching with i
E: a set of entries

Variables are:
xₖ: a decision variable of entry k (demand and
supply participation: 1, nonparticipation: 0)
yᵢⱼ: a matching decision variable between resources i and j (matching achieved: 1, not achieved: 0)
zᵢ: a decision variable of resource i (matching achieved; 1, not achieved: 0)
zₖ: a vector that collects resource decision variables that belong to entry k
Uₖ: a utility value obtained by entry k

Constants are:
Uₖ: a target value set for entry k
wᵢⱼ: a matching weight between resources i and j (matching achieved: 1, not achieved: 0)
mᵢ: a minimum value of the achieved quantity of resource i
Mᵢ: a maximum value of the achieved quantity of resource i
b: base entry

A function is defined by:
fₖ(zₖ); a function that represents a combinatorial condition of resource zₖ of entry k
(zₖ satisfies the combinatorial condition: 1, matching of all resources is not achieved: 0, zₖ does not satisfy the combinatorial condition: other than 0, 1)

The formulas (5) and (6) are formulas to which (2) and (3) are rewritten, respectively and have substantially a definition of the same optimum problem as them. Formulas (5) define an optimization problem that maximizes the utility value of a base point user. In this case, the base point user is a managing trader, a parent company of a business group, or the like, and demand-and-supply intervention that gives top priority to the benefit of the base point user, and does not consider other users except that combinatorial conditions are satisfied is made.

On the other hand, formulas (6) define an optimization problem which minimizes differences from target values of entries included in a candidate group under the condition that respective entries set target values. In this case, demand-and-supply intervention that considers target values of users other than the base point user is made, and the effect of reducing the number of entries included in the candidate group and high evaluation criterion for all entries included in the candidate group can be achieved at the same time. For this reason, it is expected to easily obtain agreement of respective users for the candidate group.

The optimization method of formulas (6) is similar to a method called an objective programming method which is well known in the field of multiobjective programming (see http://lecture.ecc.u-tokyo.ac.jp/okatu/Planning/60multi obj.html). However, the conventional objective programming method considers penalty values associated with all entries, but the present invention calculates the sum total of penalty values for only entries which participate in a candidate group.

These two different optimization problems can be expressed as mixed integer programming equivalent to a grouping method proposed by the present invention. This will be explained below.

Note that in the following discussion, the matching decision variable yᵢⱼ of resources i and j is a non-negative integer if resources are indivisible resources, or is a non-negative real number if they are divisible resources. Other formulas and variables do not depend on whether resources are divisible or indivisible.

The objective function (O₁) in formulas (5) aims at maximizing a utility value U_{b} of a base entry. The utility value Uₖ of each entry is the sum total of weights appended to matching with a resource as a matching partner of those which belong to that entry, as defined by the formula (C_{U}) in formulas (5) and (6).

For example, if desired selling and purchasing prices are set for respective resources, the difference between the desired selling and purchasing prices between matching-achieved resources can be set as a matching weight. In this case, if the difference is refunded to the user, a trading benefit of the user who registers the entry can be reflected.

The objective function (O₂) in formulas (6) aims at minimizing the sum total of penalty values associated with all entries included in the candidate group. Note that each penalty value is the difference between a target price determined for each entry and an actually obtained utility value. Since the utility value Uᵢ of each entry becomes Uᵢ=0 if that entry does not participate in the group (xᵢ=0), xᵢUᵢ=Uᵢ. Hence, the objective function can be deformed to a linear formula associated with variables in parentheses (note that Uᵢ* is a constant).

Next, the constraint formula (G) in formulas (5) and (6) represents that the base entry is included in the candidate group.

The constraint formula (C_{M}) in formulas (5) and (6) represents a demand-and-supply constraint, i.e., matching of resources, the quantity of which falls within the range from the minimum quantity mᵢ (inclusive) to the maximum quantity Mᵢ (inclusive) if an entry including resources i allows matching. This does not depend on whether each resource is divisible or indivisible, If the minimum and maximum quantities match, i.e., mᵢ=Mᵢ (e.g., if resources are indivisible resources and the quantity of resources is just one unit), an equational constraint in parentheses is used.

The constraint formula (C_{L}) in formulas (5) and (6) corresponds to a combinatorial constraint that expresses a combinatorial condition of resources that belong to each entry formally (by a single formula for the sake of simplicity). The combinatorial function f in this constraint formula is 1 if the combination of resources is allowed by an entry; 0 if the decision variables of all resources are 0; or a value other than 0 or 1 in other cases. Such definition can express the combinatorial condition of each entry.

In an actual problem, the combinatorial constraint is converted into a plurality of linear inequalities and equations in accordance with the condition defined for each entry. In the present invention, the combinatorial constraint is deformed into a form that can be input to the mixed integer programming problem solving means by expressing it by a plurality of linear inequalities and equations.

A simplest example of this combinatorial constraint is a case wherein an entry has a required condition that matching of all resources is achieved. A condition (AND{z₁, z₂, z₃}) corresponding to achievement of matching of all three resources (z₁, z₂, z₃) of entry x₁ can be expressed by a linear equation, i.e., by:
(z₁+z₂+z₃)/3=x₁ (7)
Formula (7) has a feasible solution indicating that x₁ participates in the candidate group only when matching of all resources z₁, z₂, and z₃ is achieved.

In addition, for example, a condition {C[=2](z₁, z₂, z₃}) corresponding to achievement of matching of two out of three resources (z₁, z₂, z₃) of entry x₁ can be expressed by a linear inequality, i.e., by:
(z₁z₂+z₃)/2=x₁ (8)
Formula (8) has a feasible solution indicating that x₁ participates in the candidate group only when matching of resources z₁ and z₂ is achieved, matching of resources z₂ and z₃ is achieved, or matching of resources z₁ and z₃ is achieved.

In general, an arbitrary combinatorial condition required between resources that belong to a given entry can be expressed by one or more linear equations and inequalities by adding some integer variables. For example, when the lower limit value of the quantity of resources, matching of which is to be achieved, is designated as a combinatorial condition, that condition is deformed into linear inequalities.

Even when combinatorial conditions are hierarchically combined, similar conversion can be applied. For example, a case will be examined below wherein entry x₁ including three resources (z₁, z₂, z₃) requires a combinatorial condition AND{C[≧1]{z₁, z₂}, z₃}, i.e., “entry x₁ participates in the group if matching of either or both or z₁ and z₂ is achieved (C[≧1]{z₁, z₂}) and matching of z₃ is achieved”. In this case, the combinatorial condition can be expressed by two constraint formulas, i.e., by:
(1/3)z₁+(1/3)z₂+(2/3)z₃≧x₁
(1/3)z₁+(/3)z₂+(2/3)z₃≧(4/3)x₁ (9)
Formulas (9) has a feasible solution indicating that x₁ participates in the candidate group only when matching of all resources z₁, z₂, and z₃ is achieved, matching of z₁ and z₃ is achieved, or matching of z₂ and z₃ is achieved.

The constrains (C_{X}), (C_{Y1}), and (C_{Y2}) in formulas (5) and (6) are associated with range of variables. (C_{X}) corresponds to that xᵢ and zₖ as the decision variables of an entry and resource are 0-1 variables. On the other hand, (C_{Y1}) and (C_{Y2}) are conditions associated with the variable y: the non-negative real number constraint (C_{Y1}) is required if both resources i and j corresponding to matching are divisible resources; or the non-negative integer constraint (C_{Y2}) is required if they are indivisible resources.

Note that the optimization problems given by formulas (5) and (6) are examples, and maximum and minimum constraints associated with the number of entries included in the candidate group, maximum and minimum constraints of matching quantities across a plurality of resources in a single entry, constraints associated with the sum or difference between a plurality of resources in a single entry or their combination, and the like may be added. These additional constraints can be expressed by one or more linear equations or inequalities.

A practical example of power trading will be explained below. Four entries:

```
Entry x₁:
AND{
  C[≧1]{+3AM\10},(z₁)
  C[≧1]{+3PM\8}(z₂)
}
Entry x₂:
  C[≧1]{+2AM\6} (z₃)
Entry x₃:
X OR{
  C[≧1]{−3AM\8},(z₄)
  C[≧1]{−3PM\12}(z₅)
}
Entry x₄:
AND{
  C[≧1]{−2AM\11},(z₆)
  C[≧1]{−3PM\9} (z₇)}
```

are registered, and entry x₂ is designated as a base entry. When these entries are formulated using the objective function of formulas (5), we have:

Objective function maxU₂
Constraint formulas U₂=(y₁₆+4y₂₅+y₂₇)
X₂=1
z₁≦y₁₆≦3z₁
z₂≦4y₂₅+y₂₇≦3z₂
2z₃=2y₃₄+5y₃₆
z₄≦2y₃₄≦3z₄
z₅≦4y₂₅≦3z₅
z₆≦y₁₆+5y₃₆≦2z₆
z₇≦y₂₇≦3z₇
x₁=(z₁+z₂)/2
x₂=z₃
x₃=z₄+z₅
x₄=(z₆+z₇)/2
x₁, x₂, x₃, x₄, z₁, z₂, z₃, z₄, z₅, z₆, z₇ε{0,1}
y₁₆, y₂₅, y₂₇, y₃₄, y₃₆ε{0,1} (10)

Entries x₁ and x₂ are power suppliers, and entries x₃ and x₄ are power demanders. There are two different resources (AM, PM), and prices per unit quantity are set for respective resources. Note that resources are demanded and supplied in trade units, i.e., they are indivisible resources.

Entries x₁, x₂, x₃, and x₄ respectively have demands or supply of two, one, two, and two types of resources, which are respectively represented by z₁ to z₇. Note that the minimum demand/supply volume of each resource corresponds to the left AND condition, and the maximum demand/supply volume is obtained by adding, to this volume, a volume corresponding to the right ANY condition.

Resources having different signs allow matching if their contents (AM or PM) match and a purchasing price is higher than a selling price. In this case, matching between z₁ and z₆, z₂ and z₅, z₂ and z₇, z₃ and z₄, and z₃ and z₆ is allowed, and variables indicating demand/supply volumes corresponding to their matching are respectively represented by y₁₆, y₂₅, y₂₇, y₃₄, and y₃₆.

A weight corresponding to the matching is a difference between the purchasing and selling prices, and weights corresponding to matching between z₁ and z₆, z₂ and z₅, z₂ and z₇, z₃ and z₄, and z₃ and z₆ are respectively 1, 4, 1, 2, and 5.

The utility value of each entry is the sum total of these matching weights. For example, utility value U₂ of x₂ is given by the first constraint formula of formulas (10).

The maximization condition to be attained of the utility value of the base entry (entry x₂) corresponds to the objective function (O₁) and the constraint (C_{b}) associated with the participation condition of the base entry.

The third to ninth constraint formulas of formulas (10) correspond to demand-and-supply constraints (C_{M}). Note that each resource can undergo matching with a plurality of resources.

The 10th to 13th constraint formulas of formulas (10) correspond to combinatorial constraints (C_{L}). The constraint formulas associated with entries x₁ (10th formula) and x₄ (13th formula) respectively correspond to AND constraints each indicating that the entry does not participate in the candidate group unless matching of two resources is attained at the same time. The constraint formula (12th formula) associated with x₃ corresponds to an XOR constraint indicating that the entry participates in the candidate group only when matching of either of two resources z₄ and z₅ is attained.

When this optimization problem is solved using the mixed integer programming problem solving means, an optimal value is U₂=7, and (U₁, U₂, U₃, U₄)=(2, 7, 2, 7), (x₁, x₂, x₃, x₄)=(1, 1, 1, 1), (y₁₆, y₂₅, y₂₇, y₃₄, y₃₆)=(1, 0, 1, 1, 1), and the like as one of optimal solutions at that time are obtained. This solution can be translated: when demand-and-supply matching is made for one unit between resources z₁ and z₆, one unit between z₂ and z₇, one unit between z₃ and z₄, and one unit between z₃ and z₆, the maximum value=7 of the utility value of entry x₂ is obtained, and the utility values of other entries x₁, x₃, and x₄ are respectively 2, 2, and 7.

In consideration of optimization in a form of formulas (6), the aforementioned four entries are registered, entry x₂ is designated as a base entries, and target values of entries x₁, x₂, x₃, and x₄ are respectively set as 11, 7, 8, and 9. Then, the objective function (O₂) that minimizes penalty values as differences from these target values is defined. Note that the constraint formulas are the same as those of formulas (10).

When this optimization problem is solved using the mixed integer programming problem solving means, a minimum value=7 of penalty values, and U₂=4, U₃=4, (x₁, x₂, x₃, x₄)=(0, 1, 1, 0), (y₁₆, y₂₅, y₂₇, y₃₄, y₃₆) 32 (0, 0, 0, 2, 0), and the like as one of optimal solutions are obtained. This solution can be translated: when resources z₃ and z₄ make exchange of 2 unit quantity in the candidate group to which entries x₂ and x₃ belong, the utility value of entry x₂ is 4, and that of entry x₃ is 4.

The results U₂=4 and U₃=4 in case of formulas (11) are compared with (U₁, U₂, U₃, U₄)=(2, 7, 2, 7) as that in case of formulas (10). In case of formulas (10), entries x₁ and x₃ obtain small utility values in comparison with the set target values, and even if this group is recommended, agreements of entries x₁ and x₃ are hardly obtained. On the other hand, since the results in case of formulas (11) also evaluate the utility values of the entry x₃ included the candidate group other than the base entry x₂ using the differences from the target values, it is understood that a solution that can obtain agreement more easily can be obtained.
Objective function minx₁*I₁−U₁+x₂*7−U₂+x₃*8−U₃+x₄*9−U₄
Constraint formulas U₁=(y₁₆+4y₂₅+y₂₇)
U₂=(2y₃₄+5y₃₆)
U₃=(2y₃₄+4y₂₅)
U₄=(y₁₆+5y₃₆+y₂₇)
X₂=1
z₁≦y₁₆≦3z₁
z₂≦4y₂₅+y₂₇≦3z₂
2z₃=2y₃₄+5y₃₆
z₄≦2y₃₄≦3z₄
z₅≦4y₂₅≦3z₅
z₆≦y₁₆+5y₃₆≦2z₆
z₇≦y₂₇≦3z₇
x₁=(z₁+z₂)/2
x₂=z₃
x₃=z₄+z₅
x₄=(z₆+z₇)/2
x₁, x₂, x₃, x₄, z₁, z₂, z₃, z₄, z₅, z₆, z₇ε{0,1}
y₁₆, y₂₅, y₂₇, y₃₄, y₃₆ε{0,1} (11)

Two phases of optimization methods that combine these two different optimization problems will be explained below.

The first phase aims at maximizing the utility values of respective entries using formulas (5), and the second phase makes optimization having the solution of the optimization-problem obtained in the first phase as a target value.

When these two phases of optimization are done, the target values of respective entries are automatically calculated, and the utility values of entries other than a base entry can be considered to some extent. This is a great feature of this method.

An algorithm associated with a recommendation method of a candidate group which includes base entry x_{b} using two phases of optimization methods will be explained below.

(Step 1-1) An input base entry is set as x_{b}.

(Step 1-2) Utility value constraints (C_{U}), matching constraints (C_{M}), and combinatorial constraints (C_{L}) are generated based on information of respective entries and a matching table.

(Step 2-1) If an entry whose target value is to be determined remains, that entry is set as xᵢ, and the flow advances to Step 2-2. If no such entry remains, the flow advances to Step 3-1.

(Step 2-2) An objective function (O₁) that maximizes a utility value U₁ of xᵢ is generated.

(Step 2-3) A constraint formulas (Cᵢ) associated with participation of xᵢ is generated.

(Step 2-4) Other constraint formulas (C₁) are generated if necessary.

(Step 2-5) A mixed integer linear programming problem including (O₁), (C_{U}), (C_{M}), (C_{L}), (Cᵢ), and (C₁) are input to the mixed integer programming problem solving means, and an obtained optimal solution is designated as a target value Uᵢ* of entry x₁. The flow then returns to Step 2-1.

(Step 3-1) An objective function (O₂) that minimizes the sum total of values (penalty values) corresponding to differences which dip from the target values Uᵢ* obtained in Step 2-5 in association with entries which participate in the candidate group is generated.

(Step 3-2) A constraint formulas (C_{b}) associated with participation of x_{b} is generated.

(Step 3-3) Other constraint formulas (C₂) are generated if necessary.

(Step 3-4) A fixed integer linear programming problem including (O₂), (C_{U}), (C_{M}), (C_{L}), (Cᵢ), and (C₂) are input to the mixed integer programming problem solving means. An obtained optimal value is designated as a utility value of entry x_{b}, and an obtained optimal solution is designated as a recommended candidate group.

This embodiment is characterized by the two phases of optimization. That is, a candidate group that minimizes the utility value of a base point is derived (first optimization) while setting entries xᵢ as a base entry in turn. The maximum value at that time, i.e., the maximum utility value of base entry xᵢ is set as a target value Uᵢ* of each entry. Next, a candidate group in which original base entry x_{b} participates, and which minimizes differences (penalty values) from the target values in association with entries that participate in the group is obtained (second optimization)

Note that the practical setting method of variables and the generation methods of objective functions (O₁, O₂) and constraint formulas (C_{M}, C_{L}, and the like) are as has been described above.

(Step 1-1) and (Step 1-2) are pre-processes. In (Step 1-1), a base entry is registered. In (Step 1-2), utility value constraints (C_{U}), matching constraints (C_{M}), and combinatorial constraints (C_{L}), which are common to the following formulation, are generated.

(Step 2-1) to (Step 2-5) are the first optimization phase, and target values of individual entries are determined.

In (Step 2-1), if an entry, whose target value is to be determined, is found, that entry is set as base entry xᵢ in this case, and the flow advances to Step 2-2. If the target values of all the entries have been determined, the flow advances to Step 3-1.

In (Step 2-2), (Step 2-3), and (Step 2-4), an objective function and constraint formulas required to optimize the utility value of base entry xi are generated. Note that a candidate group generated in this case is a solution that considers only optimization of the utility value of the base entry, and the utility values of other entries which participate in the candidate group are not considered at all.

In (Step 2-5), the optimization problem (formulas (5)) obtained up to the previous Step is input to the mixed integer programming problem solving means to obtain an optimal solution and optimal value. If an extremely long time is required to obtain an optimal solution, a limit time is set, and a best solution obtained until that time is determined as an optimal solution. The optimal value obtained in this case is the maximum value of the utility value of entry xᵢ, and this value will be referred to as a target value Uᵢ* of entry xᵢ hereinafter. Note that the mixed integer programming problem solving means often outputs no solution. In such case, since there is no solution in which entry xᵢ participates, entry xᵢ can be excluded in the subsequent Steps.

(Step 3-1) to (Step 3-4) are the second optimization phase that outputs a candidate group and matching, and the utility value obtained by the base entry in that case.

In (Step 3-1), (Step 3-2), and (Step 3-3), an objective function and constraint formulas required to obtain a candidate group are generated. Note that generation of the objective function in (Step 3-1) uses information of the target value of entry xᵢ generated in (Step 2-5).

In (Step 3-4), the optimization problem (e.g., formulas (6)) obtained until the previous Steps is input to the mixed integer programming problem solving means to obtain an optimal solution and optimal value. If an extremely long time is required to obtain an optimal solution, a limit time is set, and a best solution obtained until that time is determined as an optimal solution. The optimal value obtained in this step gives a combination of entries of a candidate group and matching between resources in the candidate group.

In the aforementioned example of power trading, an application result of the method using two phases of optimization will be described below. Note that x₂ is designated as a base entry.

Since the contents of Step 1 are the same as those in the above example, a description thereof will be omitted.

In Step 2, an optimization problem that maximizes the utility values of entries x₁ to x₄ is examined. In this example, an optimization problem that maximizes the utility value of x₂ is given by formulas (10), and for other entries, optimization problems, each of which includes only the objective function and base point constraints different from those of formulas (10), are generated.

When the generated optimization problems are input to the mixed integer programming problem solving means, respective optimal values U₁*=11, U₂*=7, U₃*=8, and U₄=9 are obtained.

In Step 3, the second optimization phase is executed. In this case, x₂ is designated as a base entry, and an optimization problem is generated in the sequence of formulas (6). In this case, since the target values of respective entries are U₁*=11, U₂*=7, U₃*=8, and U₄*=9, the generated optimization problem matches formulas (11).

When this optimization problem is input to the mixed integer programming problem solving means, a candidate group in which entries x₂ and x₃ participate, the utility value of entry x₂ is 4, and that of entry x₃ is 4, is obtained as a solution in the same manner as in the above example.

In this case, since the grouping apparatus of the present invention automatically designates the target values of respective entries, a candidate group which considers the target values of entries other than a base point can be recommended based on an objective reference.

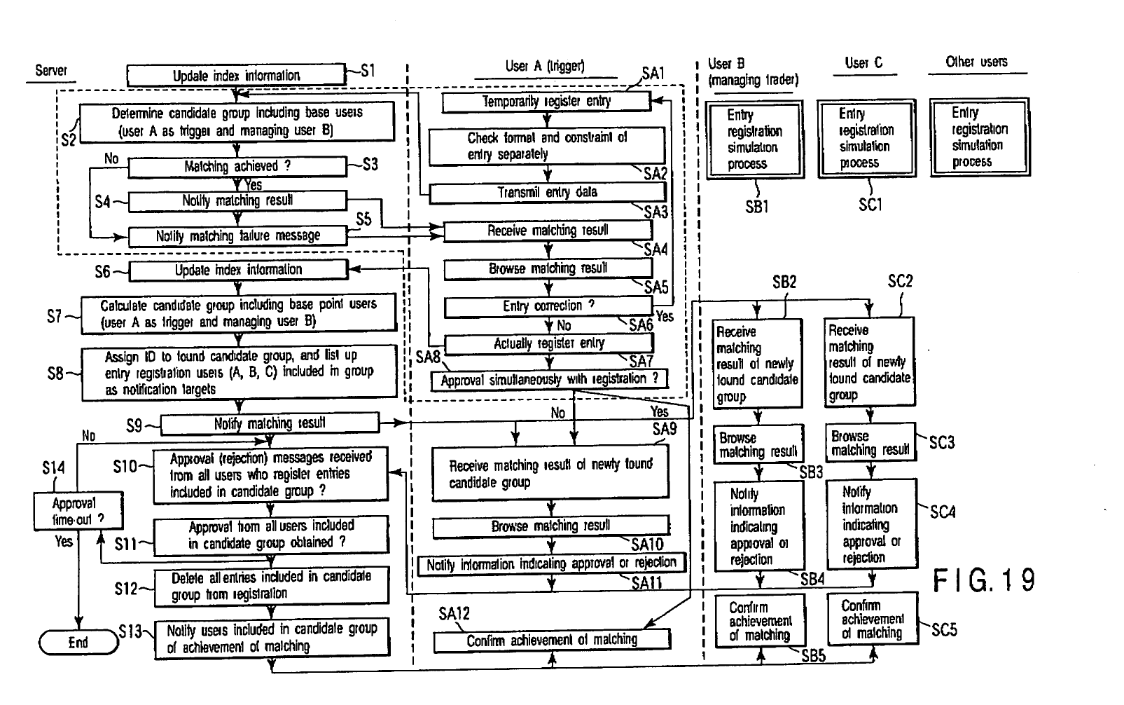

The overall flow executed when the demand-and-supply intervening systems according to the first and second embodiments are used by a plurality of users will be described below using the flowchart of FIG. 19. In this case, assume that there are three or more users, i.e., user A who serves as a base point, users B and C, and other users, and the operation on the server is also shown. The flow for other users is the same as that for users B and C. Also, the base point user is not particularly limited. In this case, user B is an important user such as a managing trader, and at least one of entries registered by user B is included in a candidate group.

The base point user simulates before formal registration if a new entry to be registered can form a candidate group with entries which have already been registered in the demand-and-supply intervening system by other users. The base point user corrects the condition of that entry according to the simulation result (processes in S2 to S5 of the server and SA1 to SA6 of user A). In the simulation process, data of respective entries (those which have already been registered by users a and C) which have already been formally registered in the demand-and-supply intervening system by other users share data with the latest contents at respective user terminals. However, data of an entry which is not formally registered yet is not reflected in arithmetic operations for other users. For example, before completion of an actual registration process in SA8 of user A, an entry which is temporarily registered in SA1 of user A is not reflected in determination of a candidate group of other users at all. Users B and C and other users also execute similar simulation processes upon registering their entries.

While the number of registered entries is small, a candidate group cannot often be found in the simulation process (No in S3). The simulation process may be omitted.

In the processes in S8 and S9 of the server, an internal ID is assigned to the found candidate group, and users (users A, B, and C in this case) who register entries included in the candidate group are listed up. Then, the respective users are notified of intra-group matching results of the candidate group. Note that the candidate group presented by the simulation process may be approved at the same time upon actual registration of an entry (Yes in SA8). In such case, the notification process to the corresponding user is skipped.

In the processes in SA9 to SA11, SB2 to SB4, and SC2 to SC4 on the user side, each individual user terminal receives the notified matching result, the user browses that result, and transmits information indicating whether or not he or she approves the matching result to the server side. The user may select to automatically approve a matching result as long as a designated combinatorial condition is satisfied.

As for the range of information of a candidate group to be browsed, which is transmitted to each user, the following limitations are set in accordance with the purpose of the demand-and-supply intervening system and individual user levels. A fewer kinds of information can be browsed as the level lowers, but when a given user does not want other users to know the entry contents, browsing is limited to level (4) below.

(1) The contents of all entries in a candidate group and their registration users can be browsed.

(2) The contents of entries which directly match an entry registered by the browsing user, and their registration users can be browsed.

(3) The quantity of matching-achieved entries with an entry, which is registered by the browsing user himself or herself, and registration users as matching partners can be browsed.

(4) Only the quantity of matching-achieved entries with an entry, which is registered by the browsing user himself or herself, can be browsed.

A GUI for browsing changes its style according to a target of the demand-and-supply intervening system.

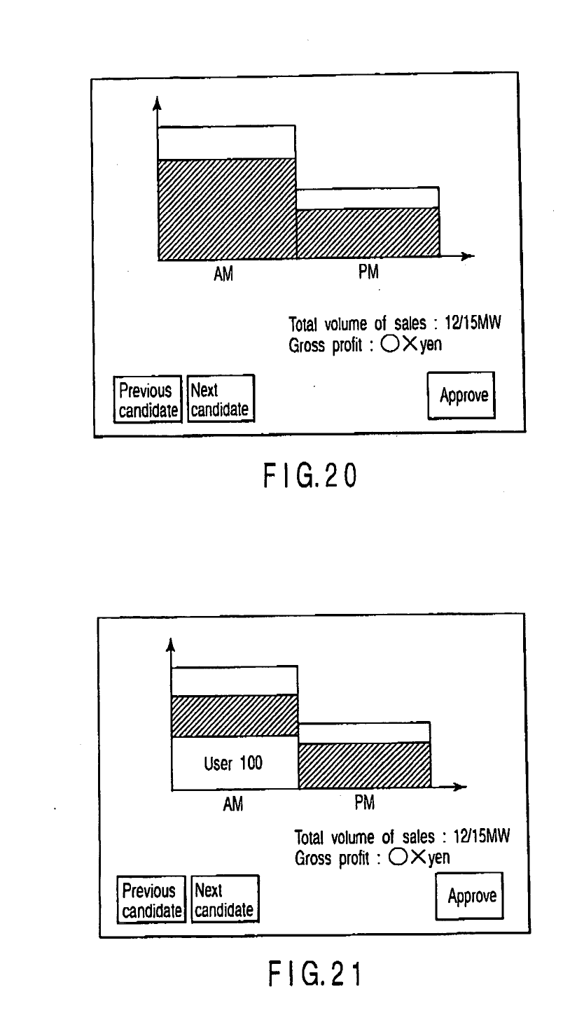

FIG. 20 shows an example of a GUI upon browsing at level (4) and FIG. 21 shows an example of a GUᵢ upon browsing at level (3) in the power trading support system.

In the processes in S10 to S14 on the server side, a candidate group settlement process is done. After approvals of all the users included in the candidate group are obtained, the users are notified of matching, and entries included in the candidate group are deleted,

### THIRD EMBODIMENT

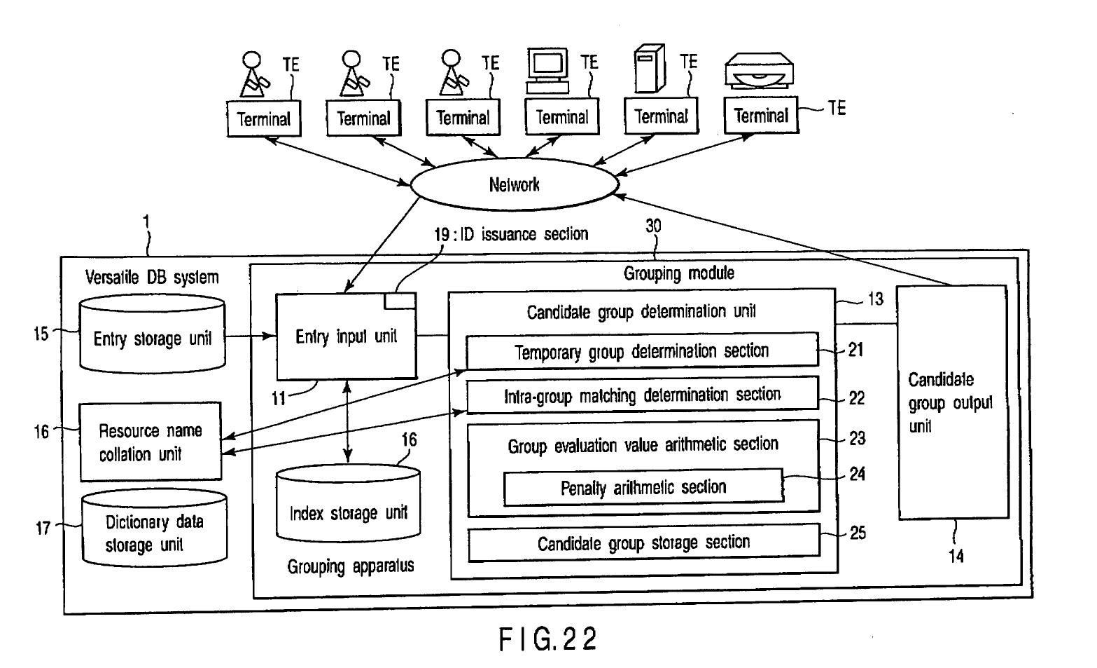

FIG. 22 is a block diagram showing the arrangement of the overall system according to the third embodiment. The same reference numerals in FIG. 22 denote the same parts as those in FIG. 1, and only differences will be explained below.

A grouping apparatus 1 shown in FIG. 22 utilizes a versatile database system which includes an entry storage unit 15 and dictionary data storage unit 17. A grouping module 31 comprises an entry input unit 11, index storage unit 16, and candidate group determination unit 13.

Unlike the grouping module 30 in FIG. 1, the grouping module 31 utilizes the versatile database system to store the contents of an entry itself, and a resource name collation unit 12 calls and uses a function such as a search data collation function included in the versatile database system.

### FOURTH EMBODIMENT

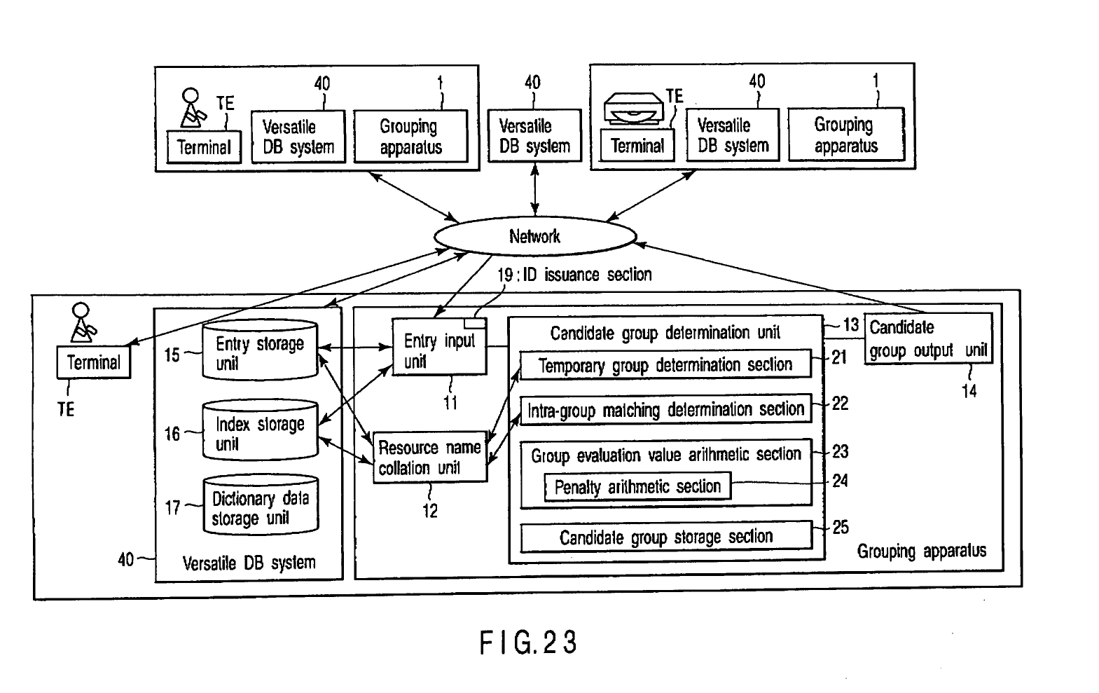

FIG. 23 is a block diagram showing the arrangement of the overall system according to the fourth embodiment. The same reference numerals in FIG. 23 denote the same parts as those in FIG. 1, and only differences will be explained below.

A grouping apparatus 1 shown in FIG. 23 comprises an entry input unit 11, resource name collation unit 12, candidate group determination unit 13, and candidate group output unit 14, and an entry storage unit 15, index storage unit 16, and dictionary data storage unit 17 are assured in a versatile database system 40. The grouping apparatus 1 accesses a desired versatile database system 40 via a network to acquire required data. A plurality of grouping apparatuses 1 are also present on the terminal side, and parallelly operate on the network. Arithmetic operations are made while sharing entries and index data. Copies of some or all of data to be shared may be generated and may be stored in a plurality of servers and terminals. In such case, these copy data are managed by an existing database technique so as not to cause inconsistency.

Upon determining a candidate group, since different users have the grouping apparatuses 1, an entry registered by a user who has the grouping apparatus is set as one of base entries. When another user registers a new entry, two entries, i.e., the new entry and the entry registered by the user who has the grouping apparatus are set as base entries.

The method of the present invention (especially, the processing operation of the grouping module 30) described in the embodiments of the present invention may be stored in a recording medium such as a magnetic disk (flexible disk, hard disk, or the like), optical disk (CD-ROM, DVD, or the like), semiconductor memory, or the like as a program that can be executed by a computer, and the recording medium that stores the program can be distributed.

In the demand-and-supply intervening system according to the present invention, even when each user freely designates a combinatorial condition to be satisfied between a plurality of resources registered by himself or herself, demand/supply destinations and demand/supply quantities that consider not only a base entry but also all combinatorial conditions designated for respective entries at the same time can be obtained as candidates. Since a candidate group of entries corresponds to the range of entries which can influence each other, demand and supply can be determined irrespective of users who register entries which are not included in the candidate group as long as approvals of users who register the entries included in the candidate group are obtained.

In place of a winner determination arithmetic operation that aims at maximizing economical index on the whole market, combinatorial optimization which uses an objective function that maximizes the benefit of a base entry and an objective function that minimizes the sun total of values (evaluation penalty values) corresponding to differences that dip from the target benefits set by users of all entries included in the candidate group is made. Hence, a candidate group which is unprofitable for a registration user of a new entry registered at the present moment, or a candidate group which is unprofitable for some users in the candidate group can be excluded.

In this way, even when a plurality of both demand and supply users designate conditions as combinations of resources, flexible demand-and-supply intervention that leaves the degree of freedom in decision making on the user side, which is equivalent to relative trading support based on a so-called bulletin board system, can be realized. For example, in a power trading support system, demand-and-supply intervention that simultaneously considers various operation characteristics to be considered by respective users such as the characteristics in terms of operation of generating facilities, power consumption patterns required for business, and the like, can be easily made within a common framework.

Note that the present invention is not limited to the above embodiments themselves. Required constituent resources can be modified and embodied without departing from the scope of the invention when it is practiced. Various inventions can be formed by appropriately combining a plurality of required constituent resources disclosed in the embodiments. For example, some required constituent resources may be deleted front all required constituent resources in the above embodiments. Furthermore, required constituent resources in different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A demand-and-supply intervening system which supports determination of a demand-and-supply relationship between users in association with demand resources and supply resources between a plurality of users, comprising:
entry acquisition means for creating an entry set by collecting a plurality of entries each of which has a plurality of resources as demand/supply objects and a combinatorial condition to be satisfied between resources; and
candidate group determination means for extracting a candidate group of entries so that all entries included in the candidate group satisfy combinatorial conditions included in each entry when extracting the candidate group having a plurality of entry which includes at least one entry designated as a base point, and determining the presence/absence of demand-and-supply relationships between demand and supply resources between entries which belong to the candidate group and demand-and-supply quantities.

2. The system according to claim 1, wherein the candidate group determination means extracts the candidate group by executing the combinatorial optimization operation that minimizes a sum total or combinatorial condition penalty values, each indicating a degree of violation to the combinatorial condition designated for each entry, of all entries included in the candidate group as an objective function.

3. The system according to claim 1 or claim 2, further comprising:
registration means for registering the plurality of entries; and
demand-and-supply candidate output means for outputting information associated with the candidate group and information associated with the demand-and-supply relationships in the candidate group, and
wherein each user who registered an entry included in the candidate group is notified of information associated with the presence/absence of the achieved demand-and-supply relationships and demand-and-supply quantities of resources included in the entry registered by that user, and it is confirmed if the user approves that information.

4. The system according to claim 3, wherein the entry has resource description data which designates a flag used to identify if a user is on the demand or supply side of that resource and the quantity of that resource, and combinatorial condition data that defines a combinational condition between a plurality of resources included in the entry, and
the combinatorial condition includes a condition that designates the quantity of resources whose demand-and-supply relationships are to be achieved or a ratio to the total quantity of that resource as a target value, or a condition that designates a lower limit value of the quantity of resources whose demand-and-supply relationships are to be achieved or a ratio to the total quantity of that resource as a target value in a set of some resources in the entry.

5. The system according to claim 4, wherein a plurality of combinatorial conditions are designated for each entry.

6. The system according to claim 4, wherein a plurality of combinatorial conditions are hierarchically combined, and
a combinatorial condition of an upper layer includes a condition that designates the number of combinatorial conditions to be satisfied or a ratio of the number of combinatorial conditions to be satisfied to the total number of combinatorial conditions or a condition that designates a lower limit value of the number of combinatorial conditions to be satisfied or a ratio of the number of combinatorial conditions to be satisfied to the total number of combinatorial conditions, in a partial set of a whole set of the plurality of combinatorial conditions.

7. The system according to claim 2, wherein the entry includes a desired selling price per unit volume of each resource, and data that designates a target value of a sum total of surpluses of the entire entry, which is differences from desired selling prices of the demand-and-supply partner, and
the candidate group determining means extracts the candidate group by using the target value of the sum total of surpluses of the entire entry.

8. The system according to claim 7, wherein the candidate group determination means extracts a candidate group by minimizing a sum of a sum total of evaluation penalty values of all entries included in the candidate group and the combinatorial condition penalty values, when a value corresponding to a difference obtained when a sum total of surpluses of resources, the demand-and-supply relationship of which is achieved, in each entry, dips from the target value of the sum total of the surpluses is defined as an evaluation penalty value.

9. The system according to claim 1, claim 2 or claim 3, wherein data of a desired selling price per unit volume of each resource is appended to the resource, and
the candidate group is found by maximizing a sum total of surpluses of resources, the demand-and-supply relationship of which is achieved, in the entry designated as the base point.

10. The system according to claim 1, claim 2 or claim 3, wherein data that designates a desired selling price per unit volume of each resource and a target value of a sum total of surpluses (differences from desired selling prices of a demand/supply partner) is appended, and
a value corresponding to a difference obtained when a sum total of surpluses of resources, the demand-and-supply relationship of which is achieved, in each entry dips front the target value of the sum total of the surpluses is defined as an evaluation penalty value, and the candidate group is found by minimizing a sum total of evaluation penalty values of all entries included in the candidate group as an objective function.

11. The system according to claim 3, wherein the candidate group determining means designates an upper limit value of the number of entries included in the candidate group.

12. The system according to claim 2, wherein the candidate group determination means executes the combinatorial optimization operation using best-first search.

13. Thus system according to claim 1, claim 2 or claim 3, wherein the entry acquisition means acquires entries, with are physically distributed and input or stored, using communication means.

14. The system according to claim 1, wherein the entry acquisition means executes an inquiry process of entries, which are physically distributed and input or stored, using communication means, upon reception of an access request from the user.

15. The system according to claim 9 or claim 10, wherein the candidate group determination means include a first optimization phase that sets, as a target value of surpluses of each registered entry, an optimal value which is obtained by maximizing a sum total of surpluses of resources, the demand-and-supply relationship of which, is achieved, in the entry as an objective function, and a second optimization phase that defines, as an evaluation penalty value, a value corresponding to a difference obtained when a sum total of surpluses of resources, the demand-and-supply relationship of which is achieved, in each entry, dips from the target value of the sum total of the surpluses, and extracts the candidate group by minimizing a sum of a sum total of evaluation penalty values of all entries included in the candidate group and the combinatorial condition penalty values.

16. A system according to one of claim 9 to claim 15, wherein the entry includes resource description data which designates a flag used to identify if it user is on the demand or supply side of that resource and the quantity of that resource, and combinatorial condition data that defines a combinatorial condition between a plurality of resources included in the entry,
the combinatorial condition includes a condition that designates the quantity of resources whose demand-and-supply relationships are to be achieved or a ratio to the total quantity of that resource as a target value, a condition that designates a lower limit value of the quantity of resources whose demand-and-supply relationships are to be achieved or a ratio to the total quantity of that resource as a target value in a set of some resources in the entry, a condition that combines a plurality of the combinatorial conditions, or a condition which is specified by hierarchically combining the combinatorial conditions, and in which a combinatorial condition of an upper layer includes a condition that designates the number of combinatorial conditions to be satisfied or a ratio of the number of combinatorial conditions to be satisfied to the total number of combinatorial conditions as a target value or a condition that designates a lower limit value of the number of combinatorial conditions to be satisfied or a ratio of the number of combinatorial conditions to be satisfied to the total number of combinatorial conditions as a target value in a partial set of a whole set of the plurality of combinatorial conditions,
the demand-and-supply intervening system further comprises:
means for converting the combinatorial condition described in each entry registered by each user into at least one linear constraint formula;
means for converting a constraint required for the entry designated as the base point to belong to the candidate group into at least one linear constraint formula;
means for converting a constraint that limits a demand-and-supply relationship between resources to resources that can achieve the demand-and-supply relationship into at least one linear constraint formula;
means for converting an optimization target into a linear objective function; and
mixed integer linear programming problem solving means for solving a mixed integer linear programming program including the constraint formulas and an objective function, and outputting values of a corresponding optimization parameter set or a signal which notifies that the problem cannot be solved, wherein
the candidate group determination means determines the candidate group, and the presence/absence of demand-and-supply relationships and demand-and-supply quantities between demand and supply resources between entries which belong to the candidate group on the basis of the output result of the mixed integer linear programming problem solving means.

17. A demand-and-supply intervening method which supports determination of a demand-and-supply relationship between users in association with demand resources and supply resources between a plurality of users, comprising:
creating an entry set by collecting a plurality of entries each of which has a plurality of resources as demand/supply objects and a combinatorial condition to be satisfied between resources; and
extracting a candidate group of entries so that all entries included in the candidate group satisfy combinatorial conditions included in each entry when extracting the candidate group having a plurality of entry which includes at least one entry designated as a base point, and determining the presence/absence of demand-and-supply relationships between demand and supply resources between entries which belong to the candidate group and demand-and-supply quantities.

18. A computer readable program which supports determination of a demand-and-supply relationship between users in association with demand resources and supply resources between a plurality of users, the program making a computer execute:
a process for creating an entry set by collecting a plurality of entries each of which has a plurality of resources as demand/supply objects and a combinatorial condition to be satisfied between resources; and
a process for extracting a candidate group of entries so that all entries included in the candidate group satisfy combinatorial conditions included in each entry when extracting the candidate group having a plurality of entry which includes at least one entry designated as a base point, and determining the presence/absence of demand-and-supply relationships between demand and supply resources between entries which belong to the candidate group and demand-and-supply quantities.
